(19) United States
(12) Patent Application Publication
(10) Pub. No.: US 2026/0241769 A1
(43) Pub. Date: Aug. 20, 2026

(54) HEAT PUMP SYSTEM FOR VEHICLE

(71) Applicant: DENSO CORPORATION, Kariya-city (JP)

(72) Inventors: Yukio UEMURA, Kariya-city (JP); Yoshihiro GOT, Kariya-city (JP); Osamu HAKAMATA, Kariya-city (JP)

(21) Appl. No.: 19/646,960

(22) Filed: Apr. 14, 2026

Related U.S. Application Data
(63) Continuation of application No. PCT/JP2024/039700, filed on Nov. 7, 2024.

(30) Foreign Application Priority Data
Dec. 1, 2023 (JP) 2023-203804

(51) Int. Cl. B60H 1/00; B60H 1/32

(52) U.S. Cl. CPC B60H 1/00921; B60H 1/00021; B60H 1/3227; B60H 2001/00171; B60H 2001/00178

(57) ABSTRACT

An ECU executes a maximum cooling mode. In this mode, the ECU drives each corresponding component of the heat medium circuit such that one of the first and second heat exchangers performs a heat-releasing function, the other one of the first and second heat exchangers performs a heat-absorbing function, and an external heat exchanger performs the heat-releasing function. The ECU drives an air path switching mechanism such that air, which has passed through the one of the first and second heat exchangers without passing through the other one of the first and second heat exchangers, is discharged from a discharge opening to outside a vehicle, and the air, which has passed through the other one of the first and second heat exchangers without passing through the one of the first and second heat exchangers, is blown from an outlet opening into a vehicle cabin.

### CROSS REFERENCE TO RELATED APPLICATIONS

This application is a continuation application of International Patent Application No. PCT/JP2024/039700 filed on Nov. 7, 2024, which designated the U.S. and claims the benefit of priority from Japanese Patent Application No. 2023-203804 filed on Dec. 1, 2023. The entire disclosures of all of the above applications are incorporated herein by reference.

### TECHNICAL FIELD

The present disclosure relates to a heat pump system for a vehicle and an air conditioning device for the vehicle.

### BACKGROUND

Previously, there has been proposed a heat pump system for a vehicle that adjusts the temperature of a heat-generating component mounted on the vehicle and performs vehicle cabin air conditioning. Hereinafter, the heat-generating component mounted on the vehicle will be referred to as “vehicle heat-generating component,” and the heat pump system for the vehicle will be sometimes simply referred to as “system.”

The previously proposed system includes: a heat medium circuit having a refrigeration cycle and a coolant circuit; and an air conditioning device that performs air conditioning of a vehicle cabin. In the refrigeration cycle, components such as a compressor, an internal condenser, an external condenser, an evaporator and a chiller are connected by refrigerant piping. The external condenser and the chiller are disposed outside the air conditioning device. The chiller is a heat exchanger that exchanges heat between a low temperature, low pressure refrigerant flowing in the refrigeration cycle and a coolant flowing in the coolant circuit. The coolant circuit is provided with a heat-generating component heat exchanger that cools the vehicle heat-generating component. Furthermore, the evaporator and the internal condenser are arranged in an air passage of the air conditioning device in this order from the upstream side. In this system, after the air flowing through the air passage is cooled by the evaporator, heat of the refrigerant flowing through the internal condenser is released into a portion of the cooled air, and that air is discharged to the outside of the vehicle from a purge passage. According to the previously proposed system, the amount of heat released by the refrigerant through the internal condenser and the external condenser in the refrigeration cycle is increased, thereby enhancing a cooling capacity of the heat-generating component heat exchanger for cooling the vehicle heat-generating component.

### SUMMARY

According to one aspect of the present disclosure, there is provided a heat pump system for a vehicle. The heat pump system may include an air conditioning case, a first heat exchanger, a second heat exchanger, an outlet opening, a discharge opening, an air path switching mechanism, an external heat exchanger, a heat medium circuit and an electronic controller. The air conditioning case may have an air passage which is configured to conduct air drawn from outside a vehicle cabin and air drawn from inside the vehicle cabin. The first heat exchanger may be disposed in the air passage of the air conditioning case and may be configured to exchange heat between the air flowing in the air passage and a heat medium. The second heat exchanger may be disposed downstream of the first heat exchanger in the air passage of the air conditioning case and may be configured to exchange heat between the air flowing in the air passage and the heat medium. The outlet opening may be disposed downstream of the first heat exchanger and the second heat exchanger in the air conditioning case and may be configured to blow the air from the air passage into the vehicle cabin. The discharge opening may be disposed downstream of the first heat exchanger in the air conditioning case and may be configured to discharge the air from the air passage to outside the vehicle cabin. The air path switching mechanism may be configured to switch, within the air passage, a flow path of the air between (i) a state in which the air flowing in the air passage flows through the first heat exchanger without passing through the second heat exchanger toward the outlet opening or the discharge opening, and (ii) a state in which the air flowing in the air passage flows through the second heat exchanger without passing through the first heat exchanger toward the outlet opening or the discharge opening. The external heat exchanger may be disposed in a space outside the air conditioning case and may be configured to exchange heat between the air outside the vehicle cabin and the heat medium. The heat medium circuit may connect the first heat exchanger, the second heat exchanger and the external heat exchanger by piping through which the heat medium flows. The heat medium circuit may include a plurality of flow path switching valves, each of which may be disposed in the piping and may be configured to switch a flow of the heat medium. The electronic controller may include at least one of (i) a circuit and (ii) a processor with a memory storing computer program code executable by the processor. The electronic controller may be configured to control operation of the air path switching mechanism and components of the heat medium circuit, which include the plurality of flow path switching valves.

For each heat exchanger, a heat-releasing function may be defined as a function of releasing heat from the heat medium flowing inside the heat exchanger to a substance outside the heat exchanger, and a heat-absorbing function may be defined as a function of absorbing heat from the substance outside the heat exchanger into the heat medium flowing inside the heat exchanger. The electronic controller may be configured to execute a maximum cooling mode, in which the electronic controller may drive each corresponding one of the components of the heat medium circuit such that one of the first heat exchanger and the second heat exchanger performs the heat-releasing function, another one of the first heat exchanger and the second heat exchanger performs the heat-absorbing function, and the external heat exchanger performs the heat-releasing function, and the electronic controller may drive the air path switching mechanism such that the air, which has passed through the one of the first heat exchanger and the second heat exchanger without passing through the another one of the first heat exchanger and the second heat exchanger, is discharged from the discharge opening to outside the vehicle cabin, and the air, which has passed through the another one of the first heat exchanger and the second heat exchanger without passing through the one of the first heat exchanger and the second heat exchanger, is blown from the outlet opening into the vehicle cabin.

### BRIEF DESCRIPTION OF DRAWINGS

The drawings described herein are for illustrative purposes only of selected embodiments and not all possible implementations, and are not intended to limit the scope of the present disclosure.

FIG. 1 is a cross-sectional view illustrating a cooling mode in a vehicle air conditioning device according to a first embodiment.

FIG. 2 is a circuit diagram illustrating the cooling mode in a heat medium circuit according to the first embodiment.

FIG. 3A is a cross-sectional view illustrating a heating mode in the vehicle air conditioning device according to the first embodiment.

FIG. 3B is a circuit diagram illustrating the heating mode in the heat medium circuit from spring to summer according to the first embodiment.

FIG. 4 is a circuit diagram illustrating a heating mode and a maximum heating mode executed in the heat medium circuit from autumn to winter according to the first embodiment.

FIG. 5 is a cross-sectional view illustrating a maximum cooling mode in the vehicle air conditioning device according to the first embodiment.

FIG. 6 is a circuit diagram illustrating the maximum cooling mode in the heat medium circuit according to the first embodiment.

FIG. 7 is a cross-sectional view illustrating the maximum heating mode in the vehicle air conditioning device according to the first embodiment.

FIG. 8 is a cross-sectional view illustrating a state during transition from the maximum cooling mode to the cooling mode in the vehicle air conditioning device according to the first embodiment.

FIG. 9 is a cross-sectional view illustrating a cooling mode in a vehicle air conditioning device according to a second embodiment.

FIG. 10 is a circuit diagram illustrating the cooling mode in a heat medium circuit according to the second embodiment.

FIG. 11 is a cross-sectional view illustrating a heating mode in a vehicle air conditioning device according to a third embodiment.

FIG. 12 is a circuit diagram illustrating a heating mode in a heat medium circuit according to the third embodiment.

FIG. 13 is a cross-sectional view illustrating a maximum cooling mode in a vehicle air conditioning device according to a fourth embodiment.

FIG. 14 is a circuit diagram illustrating the maximum cooling mode in a heat medium circuit according to the fourth embodiment.

FIG. 15 is a cross-sectional view illustrating a maximum cooling mode in a vehicle air conditioning device according to a sixth embodiment.

FIG. 16 is a circuit diagram illustrating the maximum cooling mode in a heat medium circuit according to the sixth embodiment.

FIG. 17 is a cross-sectional view illustrating a maximum heating mode in a vehicle air conditioning device according to a seventh embodiment.

FIG. 18 is a circuit diagram illustrating the maximum heating mode in a heat medium circuit according to the seventh embodiment.

FIG. 19 is a circuit diagram illustrating a maximum cooling mode in a heat medium circuit according to an eighth embodiment.

FIG. 20 is a circuit diagram illustrating the maximum heating mode in the heat medium circuit according to the eighth embodiment.

FIG. 21 is a circuit diagram illustrating a heat medium circuit according to a ninth embodiment.

FIG. 22 is a cross-sectional view illustrating a cabin heating and component heating mode in a case where frost or the like adheres to an external heat exchanger in a vehicle air conditioning device according to a fifth embodiment.

FIG. 23 is a circuit diagram illustrating the cabin heating and component heating mode in the case where the frost or the like adheres to the external heat exchanger in a heat medium circuit according to the fifth embodiment.

### DETAILED DESCRIPTION

Previously, there has been proposed a heat pump system for a vehicle that adjusts the temperature of a heat-generating component mounted on the vehicle and performs vehicle cabin air conditioning. Hereinafter, the heat-generating component mounted on the vehicle will be referred to as “vehicle heat-generating component,” and the heat pump system for the vehicle will be sometimes simply referred to as “system.”

The previously proposed system includes: a heat medium circuit having a refrigeration cycle and a coolant circuit; and an air conditioning device that performs air conditioning of the vehicle cabin. In the refrigeration cycle, components such as a compressor, an internal condenser, an external condenser, an evaporator and a chiller are connected by refrigerant piping. The external condenser and the chiller are disposed outside the air conditioning device. The chiller is a heat exchanger that exchanges heat between a low temperature, low pressure refrigerant flowing in the refrigeration cycle and a coolant flowing in the coolant circuit. The coolant circuit is provided with a heat-generating component heat exchanger that cools the vehicle heat-generating component. Furthermore, the evaporator and the internal condenser are arranged in an air passage of the air conditioning device in this order from the upstream side. In this system, after the air flowing through the air passage is cooled by the evaporator, heat of the refrigerant flowing through the internal condenser is released into a portion of the cooled air, and that air is discharged to the outside of the vehicle from a purge passage. According to the previously proposed system, the amount of heat released by the refrigerant through the internal condenser and the external condenser in the refrigeration cycle is increased, thereby enhancing a cooling capacity of the heat-generating component heat exchanger for cooling the vehicle heat-generating component.

However, the previously proposed system is inefficient because, after cooling the air with the evaporator, it warms a portion of the cooled air again with the internal condenser and discharges that air to the outside of the vehicle. That is, in order to cool the air with the evaporator, the system compresses and discharges the refrigerant with the compressor. A portion of the energy used for this is discarded to the outside of the vehicle, resulting in large energy loss and deterioration of the vehicle cabin cooling efficiency and the cooling efficiency for the vehicle heat-generating component.

According to one aspect of the present disclosure, there is provided a heat pump system for a vehicle, the heat pump system including:
an air conditioning case that has an air passage which is configured to conduct air drawn from outside a vehicle cabin and air drawn from inside the vehicle cabin;
a first heat exchanger that is disposed in the air passage of the air conditioning case and is configured to exchange heat between the air flowing in the air passage and a heat medium;
a second heat exchanger that is disposed downstream of the first heat exchanger in the air passage of the air conditioning case and is configured to exchange heat between the air flowing in the air passage and the heat medium;
an outlet opening that is disposed downstream of the first heat exchanger and the second heat exchanger in the air conditioning case and is configured to blow the air from the air passage into the vehicle cabin;
a discharge opening that is disposed downstream of the first heat exchanger in the air conditioning case and is configured to discharge the air from the air passage to outside the vehicle cabin;
an air path switching mechanism that is configured to switch, within the air passage, a flow path of the air between (i) a state in which the air flowing in the air passage flows through the first heat exchanger without passing through the second heat exchanger toward the outlet opening or the discharge opening, and (ii) a state in which the air flowing in the air passage flows through the second heat exchanger without passing through the first heat exchanger toward the outlet opening or the discharge opening;
an external heat exchanger that is disposed in a space outside the air conditioning case and is configured to exchange heat between the air outside the vehicle cabin and the heat medium;
a heat medium circuit that connects the first heat exchanger, the second heat exchanger and the external heat exchanger by piping through which the heat medium flows, wherein the heat medium circuit includes a plurality of flow path switching valves, each of which is disposed in the piping and is configured to switch a flow of the heat medium; and
an electronic controller that is configured to control operation of the air path switching mechanism and components of the heat medium circuit, which include the plurality of flow path switching valves, wherein:
for each heat exchanger, a heat-releasing function is defined as a function of releasing heat from the heat medium flowing inside the heat exchanger to a substance outside the heat exchanger, and a heat-absorbing function is defined as a function of absorbing heat from the substance outside the heat exchanger into the heat medium flowing inside the heat exchanger; and
the electronic controller is configured to execute a maximum cooling mode, in which the electronic controller drives each corresponding one of the components of the heat medium circuit such that one of the first heat exchanger and the second heat exchanger performs the heat-releasing function, another one of the first heat exchanger and the second heat exchanger performs the heat-absorbing function, and the external heat exchanger performs the heat-releasing function, and the electronic controller drives the air path switching mechanism such that the air, which has passed through the one of the first heat exchanger and the second heat exchanger without passing through the another one of the first heat exchanger and the second heat exchanger, is discharged from the discharge opening to outside the vehicle cabin, and the air, which has passed through the another one of the first heat exchanger and the second heat exchanger without passing through the one of the first heat exchanger and the second heat exchanger, is blown from the outlet opening into the vehicle cabin.

With this configuration, by setting the one of the first heat exchanger and the second heat exchanger together with the external heat exchanger to perform the heat-releasing function, it is possible to increase the amount of heat released from the heat medium in the heat medium circuit to the external substance (i.e., the air discharged from the air conditioning case to outside the vehicle cabin, and the air outside the vehicle cabin). In the heat medium circuit, the amount of heat released by the heat medium corresponds to the sum of the work of the compressor of the refrigeration cycle and the amount of heat absorbed by the heat medium. Therefore, the heat pump system can improve maximum performance. In doing so, the heat pump system discharges the air, which has passed through the one of the first heat exchanger and the second heat exchanger (i.e., the heat exchanger having the heat-releasing function) without passing through the another one of the first heat exchanger and the second heat exchanger, from the discharge opening to outside the vehicle cabin. That is, unlike the previously proposed system discussed above, this system does not reheat the air, which has been cooled by the heat exchanger having the heat-absorbing function, with the heat exchanger having the heat-releasing function, so no energy loss occurs. As a result, this heat pump system improves efficiency over the configuration of the previously proposed system described above.

According to another aspect of the present disclosure, there is provided an air conditioning device configured to be mounted on a vehicle along with a heat medium circuit that connects a first heat exchanger, a second heat exchanger and an external heat exchanger by piping through which a heat medium flows, wherein the heat medium circuit includes a plurality of flow path switching valves, each of which is disposed in the piping and is configured to switch a flow of the heat medium, the air conditioning device including:
an air conditioning case that has an air passage which is configured to conduct air drawn from outside a vehicle cabin and air drawn from inside the vehicle cabin;
the first heat exchanger that is disposed in the air passage of the air conditioning case and is configured to exchange heat between the air flowing through the air passage and the heat medium;
the second heat exchanger that is disposed downstream of the first heat exchanger in the air passage of the air conditioning case and is configured to exchange heat between the air flowing in the air passage and the heat medium;
an outlet opening that is disposed downstream of the first heat exchanger and the second heat exchanger in the air conditioning case and is configured to blow the air from the air passage into the vehicle cabin;
a discharge opening that is disposed downstream of the first heat exchanger in the air conditioning case and is configured to discharge the air from the air passage to outside the vehicle cabin;
an air path switching mechanism that is configured to switch, within the air passage, a flow path of the air between (i) a state in which the air flowing in the air passage flows through the first heat exchanger without passing through the second heat exchanger toward the outlet opening or the discharge opening, and (ii) a state in which the air flowing in the air passage flows through the second heat exchanger without passing through the first heat exchanger toward the outlet opening or the discharge opening; and
an electronic controller that is configured to control operation of the air path switching mechanism and components of the heat medium circuit, which include the plurality of flow path switching valves, wherein:
the external heat exchanger is disposed in a space outside the air conditioning case and is configured to exchange heat between the air outside the vehicle cabin and the heat medium;
for each heat exchanger, a heat-releasing function is defined as a function of releasing heat from the heat medium flowing inside the heat exchanger to a substance outside the heat exchanger, and a heat-absorbing function is defined as a function of absorbing heat from the substance outside the heat exchanger into the heat medium flowing inside the heat exchanger; and
the electronic controller is configured to execute a maximum cooling mode, in which the electronic controller drives each corresponding one of the components of the heat medium circuit such that one of the first heat exchanger and the second heat exchanger performs the heat-releasing function, another one of the first heat exchanger and the second heat exchanger performs the heat-absorbing function, and the external heat exchanger performs the heat-releasing function, and the electronic controller drives the air path switching mechanism such that the air, which has passed through the one of the first heat exchanger and the second heat exchanger without passing through the another one of the first heat exchanger and the second heat exchanger, is discharged from the discharge opening to outside the vehicle cabin, and the air, which has passed through the another one of the first heat exchanger and the second heat exchanger without passing through the one of the first heat exchanger and the second heat exchanger, is blown from the outlet opening into the vehicle cabin.

With this configuration, the air conditioning device according to the other aspect of the present disclosure can also achieve the same functions and effects as the heat pump system according to the one aspect of the present disclosure.

Hereinafter, embodiments of the present disclosure will be described with reference to the drawings. In each of the following embodiments, portions, which are the same or equivalent to each other, will be indicated by the same reference signs, and the description thereof will be omitted.

### First Embodiment

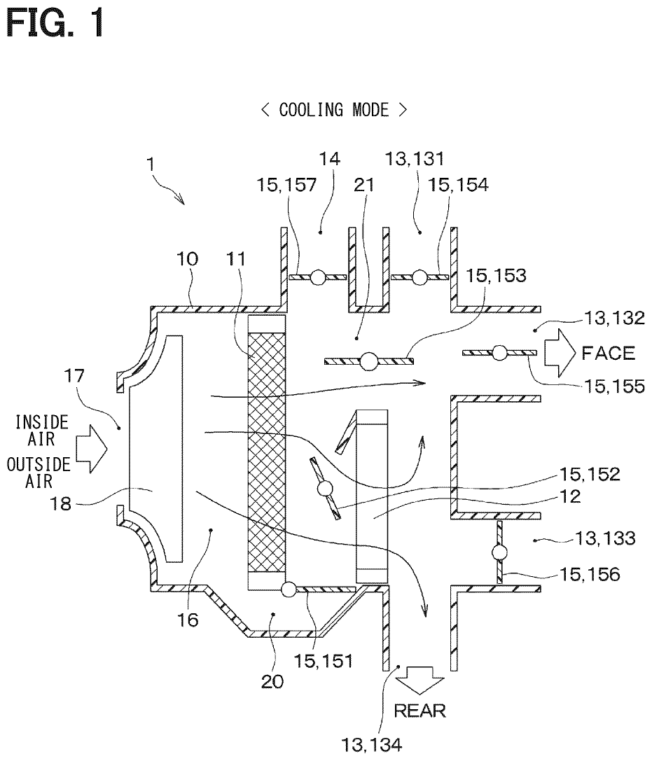

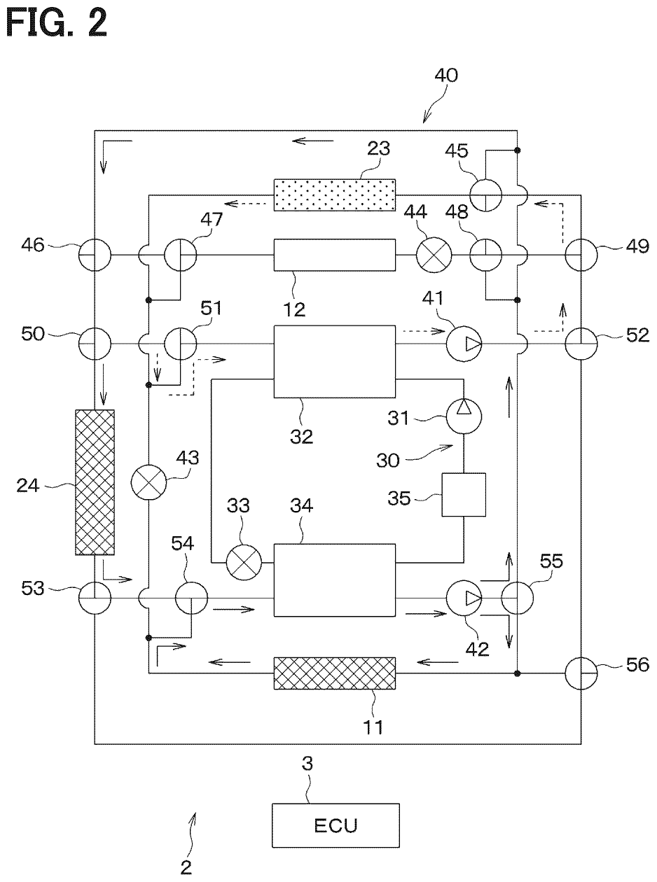

The first embodiment will be described. A heat pump system for a vehicle (hereinafter referred to as a vehicle heat pump system) of the present embodiment performs temperature control of a heat-generating component mounted on a vehicle and air conditioning inside a vehicle cabin. As shown in FIGS. 1 and 2, the vehicle heat pump system includes an air conditioning device 1 for a vehicle, a heat medium circuit 2 and an electronic controller 3. Hereinafter, the air conditioning device 1 for the vehicle will be referred to simply as “air conditioning device 1,” and the electronic controller 3 will be referred to as “ECU 3.” Here, ECU stands for Electronic Control Unit.

### Configuration of Air Conditioning Device 1

First, a configuration of the air conditioning device 1 will be described.

As shown in FIG. 1, the air conditioning device 1 is of a reheat type and includes an air conditioning case 10, a first heat exchanger 11, a second heat exchanger 12, a plurality of outlet openings 13, a discharge opening 14 and an air path switching mechanism 15. The first heat exchanger 11 and the second heat exchanger 12 form part of the heat medium circuit 2.

The air conditioning case 10 is made of a resin material such as polypropylene and has, on its inside, an air passage 16 through which air flows. The air conditioning case 10 is provided with an air intake opening 17, the outlet openings 13 and the discharge opening 14. A blower 18, the first heat exchanger 11, the second heat exchanger 12 and the air path switching mechanism 15 are disposed inside the air conditioning case 10.

The air conditioning device 1 is configured to selectively introduce outside air (air outside the vehicle cabin, hereinafter referred to as “outside air”) and inside air (air inside the vehicle cabin, hereinafter referred to as “inside air”) into the air passage 16 through the air intake opening 17. Hereinafter, the outside air and the inside air are collectively referred to simply as “air.” When the blower 18 is driven, the air drawn through the air intake opening 17 flows in the air passage 16 and is blown from the outlet openings 13 or the discharge opening 14.

Each of the first heat exchanger 11 and the second heat exchanger 12 is configured to exchange heat between the air that passes through the heat exchanger 11, 12 in the air passage 16 (i.e., a substance outside the heat exchanger 11, 12) and a heat medium flowing inside the heat exchanger 11, 12. In the description below, a function of releasing heat from the heat medium flowing inside the heat exchanger to the substance outside the heat exchanger will be referred to as “heat-releasing function.” Furthermore, a function of absorbing heat from the substance outside the heat exchanger into the heat medium flowing inside the heat exchanger will be referred to as “heat-absorbing function.” In the present embodiment, by operation of the heat medium circuit 2 described later, the first heat exchanger 11 and the second heat exchanger 12 are configured to be switchable between performing the heat-releasing function and performing the heat-absorbing function.

In the air passage 16 of the air conditioning case 10, the first heat exchanger 11 is disposed upstream of the second heat exchanger 12. A size of the first heat exchanger 11 is larger than a size of the second heat exchanger 12. Specifically, a volume obtained by multiplying a length, a width and a height of an outer shape of the first heat exchanger 11 is larger than a volume obtained by multiplying a length, a width and a height of an outer shape of the second heat exchanger 12. In addition, a passage cross-sectional area of the first heat exchanger 11 for conducting the air is larger than a passage cross-sectional area of the second heat exchanger 12 for conducting the air. In the air passage 16 of the air conditioning case 10, the term “upstream side” refers to an upstream side in a flow direction of the air when the air path switching mechanism 15 is opened, and the term “downstream side” refers to a downstream side in the flow direction of the air when the air path switching mechanism 15 is opened.

In the air passage 16, a first heat exchanger bypass passage 20 is formed between the first heat exchanger 11 and an inner wall of the air conditioning case 10. The first heat exchanger bypass passage 20 allows the air, which is drawn through the air intake opening 17, to flow therethrough while bypassing the first heat exchanger 11. A cold air bypass passage 21 is formed between the second heat exchanger 12 and the inner wall of the air conditioning case 10. The cold air bypass passage 21 allows the air, which has passed through or bypassed the first heat exchanger 11, to flow therethrough while bypassing the second heat exchanger 12.

The outlet openings 13 are disposed downstream of the first heat exchanger 11 and the second heat exchanger 12 in the air conditioning case 10. Furthermore, the outlet openings 13 are disposed downstream of the cold air bypass passage 21. The air, which is to be blown from the air passage 16 into the vehicle cabin, flows through the outlet openings 13. Specifically, the outlet openings 13 include a defroster outlet opening 131, a face outlet opening 132, a foot outlet opening 133 and a rear passage 134. The defroster outlet opening 131, the face outlet opening 132 and the foot outlet opening 133 are connected via ducts (not shown) to a defroster outlet, a face outlet and a foot outlet provided in the vehicle cabin (not shown), respectively. Accordingly, the air, which is blown toward a front windshield of the vehicle, flows through the defroster outlet opening 131. The air, which is blown toward an upper body of an occupant, flows through the face outlet opening 132. The air, which is blown toward a lower body of the occupant, flows through the foot outlet opening 133. The rear passage 134 is connected to a space on a rear seat side of the vehicle. Accordingly, the air, which is blown from the air passage 16 to the space on the rear seat side, flows through the rear passage 134.

The discharge opening 14 is disposed downstream of the first heat exchanger 11 in the air conditioning case 10. In the first embodiment, the discharge opening 14 is disposed in a region that is downstream of the first heat exchanger 11 and upstream of the second heat exchanger 12 in the air conditioning case 10. Furthermore, the discharge opening 14 is disposed upstream of the outlet openings 13. The discharge opening 14 is connected to a space outside the vehicle cabin. Accordingly, the air, which is to be discharged from the air passage 16 to outside the vehicle cabin, flows through the discharge opening 14.

The air path switching mechanism 15 includes a first heat exchanger bypass door 151, a switching door 152, a cold air bypass door 153, a defroster door 154, a face door 155, a foot door 156 and a discharge door 157. The air path switching mechanism 15 is configured to switch a flow path of the air within the air passage 16.

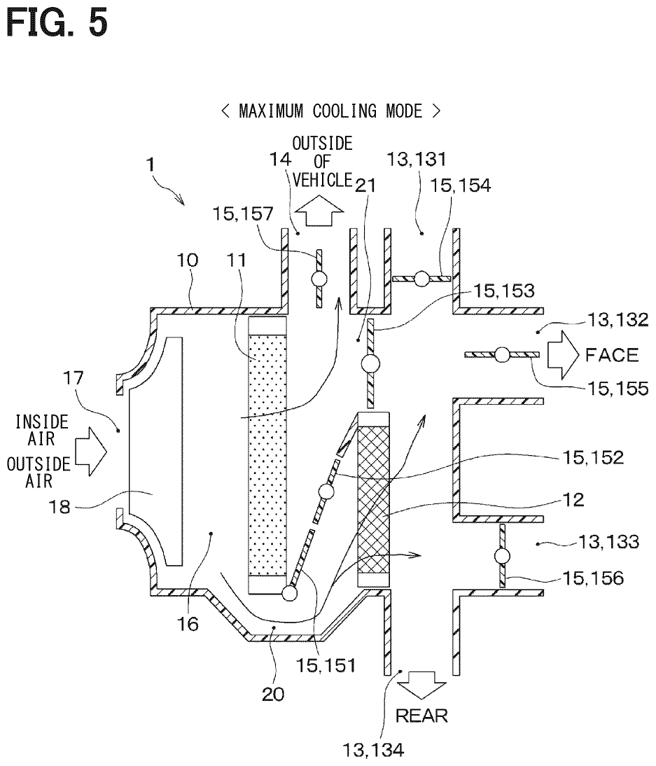

The first heat exchanger bypass door 151 opens and closes the first heat exchanger bypass passage 20. The switching door 152 is disposed between the first heat exchanger 11 and the second heat exchanger 12 in the air passage 16. As shown in FIG. 5, the switching door 152, together with the first heat exchanger bypass door 151, can direct the air, which has bypassed the first heat exchanger 11, to the second heat exchanger 12. Furthermore, as shown in FIG. 1, the switching door 152 can also direct the air, which has passed through the first heat exchanger 11, to the second heat exchanger 12. The first heat exchanger bypass door 151 and the switching door 152 may be configured to operate in an interlocked manner, or may be driven independently.

The cold air bypass door 153 is a door that opens and closes the cold air bypass passage 21. The defroster door 154 is a door that opens and closes the defroster outlet opening 131. The face door 155 is a door that opens and closes the face outlet opening 132. The foot door 156 is a door that opens and closes the foot outlet opening 133. The discharge door 157 is a door that opens and closes the discharge opening 14.

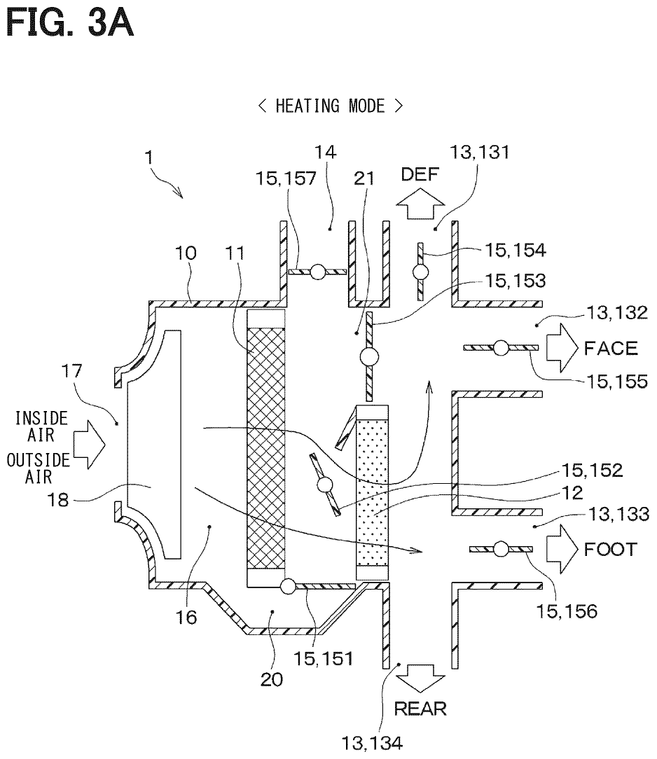

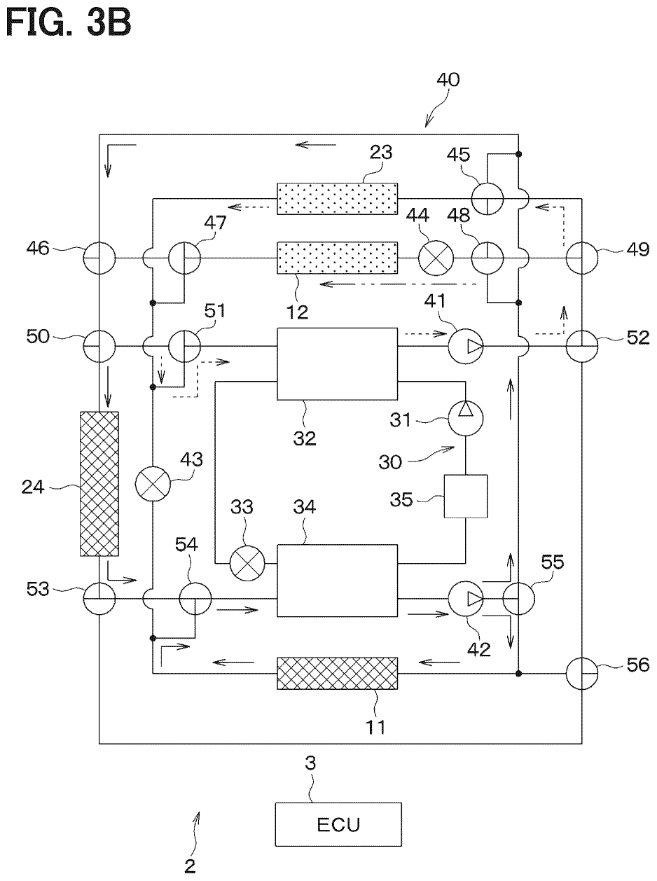

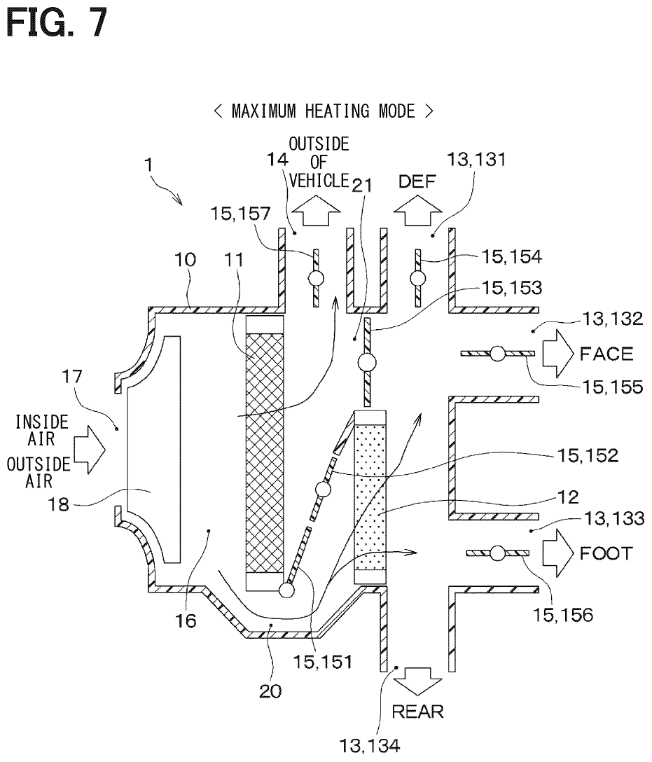

As shown in FIGS. 1 and 3A, the air path switching mechanism 15 can set a state in which the air drawn through the air intake opening 17 is directed to the outlet openings 13 through both the first heat exchanger 11 and the second heat exchanger 12. As shown in FIGS. 5 and 7, the air path switching mechanism 15 can also set a state in which a portion of the air drawn through the air intake opening 17 is directed to the discharge opening 14 through the first heat exchanger 11 without passing through the second heat exchanger 12. At the same time, the air path switching mechanism 15 can set a state in which another portion of the air drawn through the air intake opening 17 is directed to the outlet openings 13 through the second heat exchanger 12 after passing through the first heat exchanger bypass passage 20 without passing through the first heat exchanger 11.

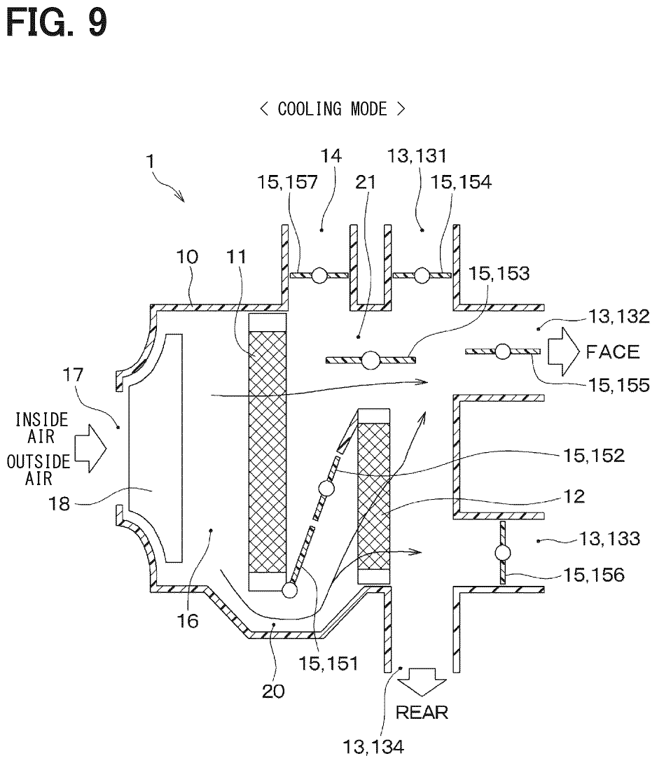

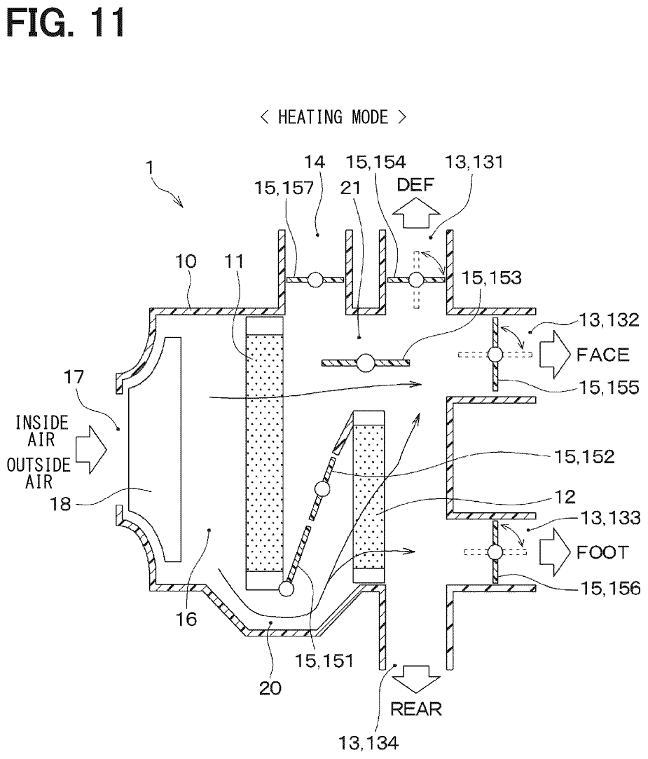

Furthermore, as shown in FIGS. 9 and 11, the air path switching mechanism 15 can set a state in which a portion of the air drawn through the air intake opening 17 is directed to the outlet openings 13 through the first heat exchanger 11 without passing through the second heat exchanger 12. At the same time, the air path switching mechanism 15 can set a state in which another portion of the air drawn through the air intake opening 17 is directed to the outlet openings 13 through the second heat exchanger 12 after passing through the first heat exchanger bypass passage 20 without passing through the first heat exchanger 11.

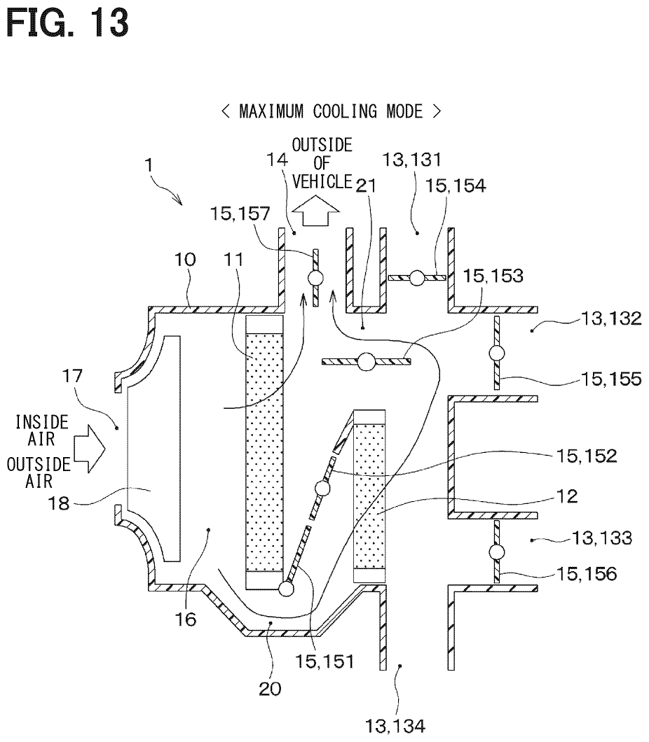

Moreover, as shown in FIG. 13, the air path switching mechanism 15 can set a state in which a portion of the air drawn through the air intake opening 17 is directed to the discharge opening 14 through the first heat exchanger 11 without passing through the second heat exchanger 12. At the same time, the air path switching mechanism 15 can set a state in which another portion of the air drawn through the air intake opening 17 is directed to the discharge opening 14 through the first heat exchanger bypass passage 20 and then through the second heat exchanger 12 without passing through the first heat exchanger 11. Although not illustrated, starting from the state shown in FIG. 13, the air path switching mechanism 15 can be actuated to open the switching door 152, thereby setting a state in which the air flowing in the air passage 16 is directed to the discharge opening 14 through both the first heat exchanger 11 and the second heat exchanger 12.

The doors included in the air path switching mechanism 15 are not limited to plate doors shown in the drawings and may be various doors such as sliding doors, rotary doors, or film doors.

### Configuration of Heat Medium Circuit 2

Next, the configuration of the heat medium circuit 2 will be described. The heat medium circuit 2 described below is one example of the present disclosure and does not limit the present disclosure.

As shown in FIG. 2, the heat medium circuit 2 is formed by connecting the first heat exchanger 11, the second heat exchanger 12, an external heat exchanger 23 and a heat-generating component heat exchanger 24 by piping through which the heat medium flows. The external heat exchanger 23 is a heat exchanger that exchanges heat between the outside air and the heat medium. The external heat exchanger 23 is disposed in a space outside the air conditioning case 10, for example, in an engine room or a traction motor room of the vehicle. The heat-generating component heat exchanger 24 is a heat exchanger that exchanges heat between a vehicle heat-generating component(s) such as a battery or an inverter (i.e., a substance outside the heat exchanger) and the heat medium. The heat-generating component heat exchanger 24 may be configured to exchange heat directly with the vehicle heat-generating component, or may be configured to exchange heat with the vehicle heat-generating component via a predetermined heat medium.

The heat medium circuit 2 of the present embodiment includes: a refrigeration cycle 30 that is configured to circulate a refrigerant as a first heat medium; and a coolant circuit 40 that is configured to circulate a coolant as a second heat medium. The refrigerant circulated in the refrigeration cycle 30 may be, for example, an HFC refrigerant (e.g., R134a), an HFO refrigerant (e.g., R1234yf), or a natural refrigerant (e.g., carbon dioxide). Furthermore, the coolant circulated in the coolant circuit 40 may be, for example, water or LLC. Here, LLC stands for Long Life Coolant.

The refrigeration cycle 30 is a vapor compression type cycle in which a compressor 31, a condenser 32, an expansion valve 33, an evaporator 34 and an accumulator 35 are connected in a loop by refrigerant piping in this order. The compressor 31 compresses a gas-phase refrigerant drawn in through a refrigerant suction port and discharges the refrigerant at high temperature and high pressure through a refrigerant discharge port. The refrigerant discharged from the compressor 31 flows into the condenser 32. The condenser 32 is a heat exchanger (specifically, a water-cooled condenser) that exchanges heat between the coolant flowing in the coolant circuit 40 and the refrigerant to heat the coolant and condense the refrigerant. The expansion valve 33 depressurizes and expands the refrigerant supplied from the condenser 32 to supply it to the evaporator 34 in a low-temperature, low-pressure gas-liquid two-phase state. The evaporator 34 is a heat exchanger (specifically, a chiller) that exchanges heat between the coolant flowing in the coolant circuit 40 and the refrigerant to cool the coolant and evaporate the refrigerant.

The coolant circuit 40 connects the first heat exchanger 11, the second heat exchanger 12, the external heat exchanger 23, the heat-generating component heat exchanger 24, a plurality of pumps 41, 42, a plurality of flow-rate control valves 43, 44 and a plurality of flow path switching valves 45-56 together with the condenser 32 and the evaporator 34 by coolant piping through which the coolant flows. Hereinafter, the coolant piping will be referred to as “piping.” In the present embodiment, the first heat exchanger 11, the second heat exchanger 12, the external heat exchanger 23 and the heat-generating component heat exchanger 24 are disposed in the coolant circuit 40.

The plurality of pumps include a first pump 41 and a second pump 42 and adjust the flow rate of the coolant flowing in the circuit. In the piping, the first pump 41 is disposed in a pipe on the condenser 32 side, and the second pump 42 is disposed in a pipe on the evaporator 34 side. In the present embodiment, the pumps 41, 42 are water pumps.

The flow-rate control valves include a first flow-rate control valve 43 and a second flow-rate control valve 44. The first flow-rate control valve 43 and the second flow-rate control valve 44 are configured to adjust the flow rate of the coolant flowing in the circuit and also shut off the flow of the coolant. The first flow-rate control valve 43 is disposed in a pipe that connects a pipe on the evaporator 34 side and a pipe on the condenser 32 side. The second flow-rate control valve 44 is disposed in a pipe upstream of the second heat exchanger 12.

The flow path switching valves 45-56 are configured to switch the flow of the coolant. In the present embodiment, three-way valves are used as the flow path switching valves 45-56, but the number of ports is not limited to three and multi-port valves such as four-way valves may be used. The locations where the pumps 41, 42, the flow-rate control valves 43, 44 and the flow path switching valves 45-56 are installed, and the routing of the piping, can also be set arbitrarily.

The ECU 3 is configured around a microcomputer having a processor such as a CPU and a memory such as a ROM, a RAM and a flash memory. The ECU 3 executes a program stored in the memory by the processor, and controls operation of the compressor 31 in the refrigeration cycle 30, the pumps 41, 42, the flow path switching valves 45-56, the flow-rate control valves 43, 44 in the coolant circuit 40, and the like. The ECU 3 also controls operation of the blower 18 and the air path switching mechanism 15 of the air conditioning device 1.

### Operating Modes of Vehicle Heat Pump System

Next, a plurality of operating modes of the vehicle heat pump system executed by the ECU 3 in the present embodiment will be described.

In the respective drawings, heat exchangers performing the heat-releasing function are indicated with dots, and heat exchangers performing the heat-absorbing function are indicated with cross-hatching. In the drawings of the heat medium circuit, directions in which the high-temperature heat medium flows are indicated by dotted line arrows, and directions in which the low-temperature heat medium flows are indicated by solid line arrows.

Although the coolant is not limited to the water, for convenience of description below, the high-temperature coolant is referred to as “hot water,” and the low-temperature coolant is referred to as “cold water.”

### Cooling Mode

A cooling mode will be described. As shown in FIG. 1, in a case of executing the cooling mode, the ECU 3 drives the first heat exchanger bypass door 151 to close the first heat exchanger bypass passage 20 and drives the cold air bypass door 153 to open the cold air bypass passage 21. The ECU 3 drives the switching door 152 to allow the air to flow from the first heat exchanger 11 to the second heat exchanger 12. The ECU 3 drives the discharge door 157 to close the discharge opening 14.

Also, the ECU 3 drives the compressor 31 and drives the flow path switching valves 45-56 such that the hot water and the cold water flow as shown by the dotted line arrows and solid line arrows in FIG. 2. Furthermore, the ECU 3 closes the first flow-rate control valve 43 and the second flow-rate control valve 44. The coolant flowing in the coolant circuit 40 becomes the hot water while passing through the condenser 32 and becomes the cold water while passing through the evaporator 34. Therefore, the cold water flows through the first heat exchanger 11. Furthermore, the flow of coolant through the second heat exchanger 12 is shut off, and the hot water flows to the external heat exchanger 23. Accordingly, the first heat exchanger 11 performs the heat-absorbing function, and the second heat exchanger 12 is stopped. Furthermore, the external heat exchanger 23 performs the heat-releasing function. In addition, the cold water flows through the heat-generating component heat exchanger 24, which therefore performs the heat-absorbing function.

Thus, as shown in FIG. 1, the air, which has passed through both the first heat exchanger 11 and the second heat exchanger 12, is blown from the outlet opening 13 (specifically, the face outlet opening 132 and the rear passage 134) into the vehicle cabin. At this time, since the cold air, which is produced by passing through the first heat exchanger 11, can flow through both the cold air bypass passage 21 and the second heat exchanger 12, pressure loss of the air flowing in the air passage 16 is reduced, thereby increasing the flow rate of the air. Thus, maximum cooling in the vehicle cabin is possible.

### Dehumidifying Heating Mode

A dehumidifying heating mode will be described. As shown in FIG. 3A, in a case of executing the dehumidifying heating mode, the ECU 3 drives the first heat exchanger bypass door 151 to close the first heat exchanger bypass passage 20 and drives the cold air bypass door 153 to close the cold air bypass passage 21. The ECU 3 drives the switching door 152 to allow the air to flow from the first heat exchanger 11 to the second heat exchanger 12. The ECU 3 drives the discharge door 157 to close the discharge opening 14.

Also, the ECU 3 drives the compressor 31. Also, the ECU 3 drives the flow path switching valves 45-56 such that the hot water and the cold water flow as shown by the dotted line arrows and the solid line arrows in FIG. 3B. Furthermore, the ECU 3 closes the first flow-rate control valve 43. Further, the ECU 3 adjusts the opening degree of the second flow-rate control valve 44, and adjusts the flow rate of the hot water flowing to the second heat exchanger 12 as indicated by the dot-dot-dash line arrows in FIG. 3B. As a result, the cold water flows through the first heat exchanger 11, and the hot water flows through the second heat exchanger 12. Furthermore, the hot water flows through the external heat exchanger 23. Accordingly, the first heat exchanger 11 performs the heat-absorbing function, and the second heat exchanger 12 performs the heat-releasing function. Furthermore, the external heat exchanger 23 performs the heat-releasing function. In addition, the cold water flows through the heat-generating component heat exchanger 24, which therefore performs the heat-absorbing function. The dehumidifying heating mode shown in FIG. 3B sets the external heat exchanger 23 to perform the heat-releasing function, and therefore dehumidifying heating mode is mainly executed from spring to summer.

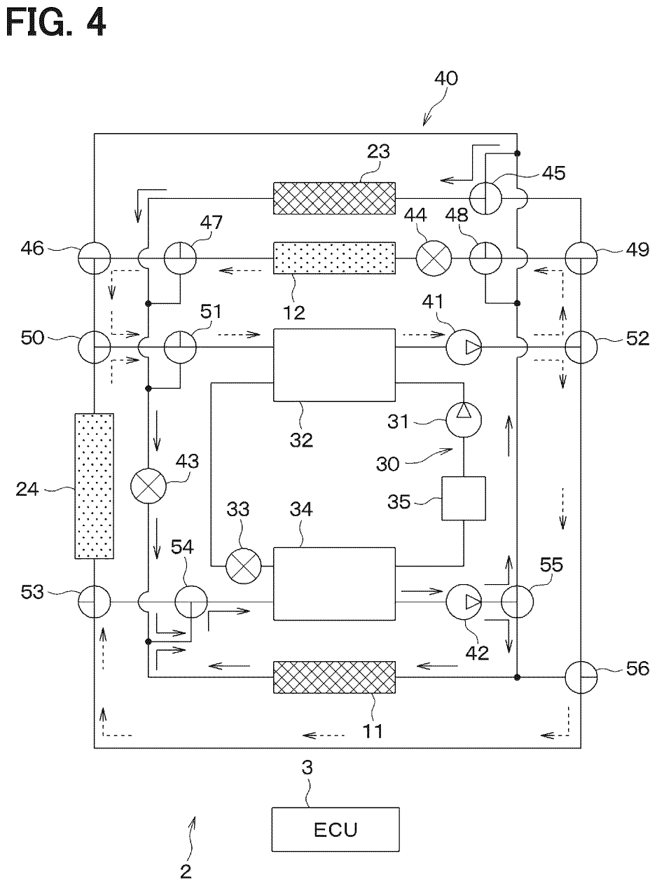

In contrast, from autumn to winter, the dehumidifying heating mode can be executed such that the external heat exchanger 23 performs the heat-absorbing function, as shown in FIG. 4. The ECU 3 drives the compressor 31 and drives the flow path switching valves 45-56 such that the hot water and the cold water flow as indicated by the dotted line arrows and the solid line arrows in FIG. 4. Furthermore, the ECU 3 opens the first flow-rate control valve 43 and the second flow-rate control valve 44. As a result, the cold water flows through the first heat exchanger 11, and the hot water flows through the second heat exchanger 12. Furthermore, the cold water flows through the external heat exchanger 23. Accordingly, the first heat exchanger 11 performs the heat-absorbing function, and the second heat exchanger 12 performs the heat-releasing function. Furthermore, the external heat exchanger 23 performs the heat-absorbing function. In addition, the hot water flows through the heat-generating component heat exchanger 24, which therefore performs the heat-releasing function.

Thus, as shown in FIG. 3A, the air, which has passed through both the first heat exchanger 11 and the second heat exchanger 12, is blown from the outlet openings 13 into the vehicle cabin. In this case, when the flow rate of the hot water supplied to the second heat exchanger 12 is maximized by adjusting the opening degree of the second flow-rate control valve 44, maximum heating in the vehicle cabin is possible. Also, by adjusting the opening degree of the second flow-rate control valve 44 to adjust the flow rate of the hot water supplied to the second heat exchanger 12, the temperature of the warm air blown into the vehicle cabin can be adjusted.

### Maximum Cooling Mode

A maximum cooling mode will be described. As shown in FIG. 5, at the time of executing the maximum cooling mode, the ECU 3 drives the first heat exchanger bypass door 151 and the switching door 152. The ECU 3 drives the first heat exchanger bypass door 151 and the switching door 152 such that the air, which has passed through the first heat exchanger 11, is prevented from flowing to the second heat exchanger 12, while allowing the air, which has passed through the first heat exchanger bypass passage 20, to flow to the second heat exchanger 12. Furthermore, the ECU 3 drives the cold air bypass door 153 to close the cold air bypass passage 21 and drives the discharge door 157 to open the discharge opening 14. Also, the ECU 3 opens the door of the outlet opening 13 (e.g., the face door 155). Therefore, the air, which has passed through the first heat exchanger 11 without passing through the second heat exchanger 12, is discharged from the discharge opening 14 to outside the vehicle cabin. Furthermore, the air, which has passed through the second heat exchanger 12 without passing through the first heat exchanger 11, is blown from the outlet opening 13 into the vehicle cabin.

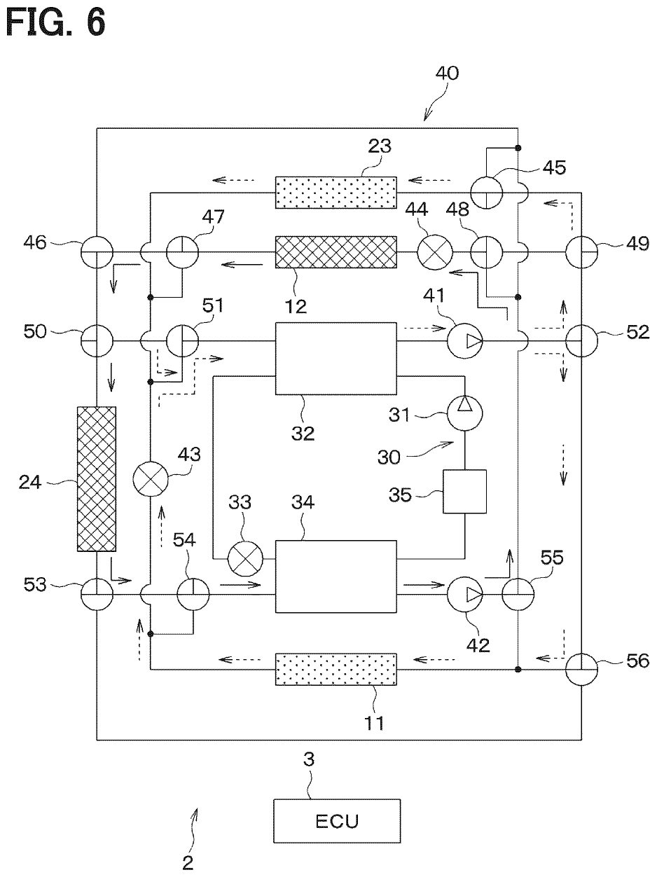

Also, the ECU 3 drives the compressor 31 and drives the flow path switching valves 45-56 such that the hot water and the cold water flow as indicated by the dotted line arrows and the solid line arrows in FIG. 6, and the ECU 3 opens the first flow-rate control valve 43 and the second flow-rate control valve 44. As a result, the hot water flows to the first heat exchanger 11, and the cold water flows to the second heat exchanger 12. Furthermore, the hot water flows to the external heat exchanger 23. Accordingly, the first heat exchanger 11 performs the heat-releasing function, and the second heat exchanger 12 performs the heat-absorbing function. Furthermore, the external heat exchanger 23 performs the heat-releasing function. In addition, the cold water flows through the heat-generating component heat exchanger 24, which therefore performs the heat-absorbing function.

Thus, since the air, which has passed through the first heat exchanger 11, is discharged from the discharge opening 14 to outside the vehicle cabin, the first heat exchanger 11 functions as a radiator, similar to the external heat exchanger 23, making it possible to increase the heat-releasing capacity of the heat medium circuit 2. Therefore, the cooling capacity of the heat-generating component heat exchanger 24 for the vehicle heat-generating component is increased, enabling maximum cooling of the vehicle heat-generating component. Furthermore, the second heat exchanger 12 performs the heat-absorbing function, and thereby cooling of the vehicle cabin can also be performed at the same time. In this case, neither the first heat exchanger 11 nor the second heat exchanger 12 performs operation such as reheating the cooled air and discharging it outside the vehicle or recooling the heated air and discharging it outside the vehicle, as in the previously proposed system discussed above. Therefore, no unnecessary energy loss occurs in the heat medium circuit 2.

In the present embodiment, the size of the first heat exchanger 11 is larger than the size of the second heat exchanger 12. This makes it possible to increase the heat-releasing capacity of the first heat exchanger 11, thereby further increasing the cooling capacity of the heat-generating component heat exchanger 24 for the vehicle heat-generating component.

### Maximum Heating Mode

A maximum heating mode will be described. As shown in FIG. 7, at the time of executing the maximum heating mode, the ECU 3 opens the doors of the outlet openings 13 (e.g., the defroster door 154, the face door 155 and the foot door 156) in contrast to the maximum cooling mode described above. Therefore, the air, which has passed through the second heat exchanger 12 without passing through the first heat exchanger 11, is blown from the outlet openings 13 into the vehicle cabin. Therefore, even in the maximum heating mode, as in the maximum cooling mode, the air, which has passed through the first heat exchanger 11 without passing through the second heat exchanger 12, is discharged from the discharge opening 14 to outside the vehicle cabin.

The state of the heat medium circuit 2 in the maximum heating mode is the same as that shown in FIG. 4. That is, the ECU 3 drives the compressor 31 and drives the flow path switching valves 45-56 such that the hot water and the cold water flow as indicated by the dotted line arrows and the solid line arrows in FIG. 4, and the ECU 3 opens the first flow-rate control valve 43 and the second flow-rate control valve 44. As a result, the cold water flows through the first heat exchanger 11, and the hot water flows through the second heat exchanger 12. Furthermore, the cold water flows through the external heat exchanger 23. Accordingly, the first heat exchanger 11 performs the heat-absorbing function, and the second heat exchanger 12 performs the heat-releasing function. Furthermore, the external heat exchanger 23 performs the heat-absorbing function. In addition, the hot water flows through the heat-generating component heat exchanger 24, which therefore performs the heat-releasing function.

Thus, since the air, which has passed through the first heat exchanger 11, is discharged from the discharge opening 14 to outside the vehicle cabin, the first heat exchanger 11 functions as a heat absorber like the external heat exchanger 23, making it possible to increase the heat-absorbing capacity of the heat medium circuit 2. Therefore, the heat-releasing capacity (i.e., heating capacity) for the vehicle heat-generating component by the heat-generating component heat exchanger 24 is increased, enabling maximum heating (e.g., warm-up) of the vehicle heat-generating component. Furthermore, the second heat exchanger 12 performs the heat-releasing function, and thereby heating of the vehicle cabin can also be performed at the same time. Even in this case, neither the first heat exchanger 11 nor the second heat exchanger 12 performs the operation such as reheating the cooled air and discharging it outside the vehicle or recooling the heated air and discharging it outside the vehicle, as in the previously proposed system discussed above. Therefore, no unnecessary energy loss occurs in the heat medium circuit 2.

In the present embodiment, the size of the first heat exchanger 11 is larger than the size of the second heat exchanger 12. This makes it possible to increase the heat-absorbing capacity of the first heat exchanger 11, thereby further increasing the heating capacity of the heat-generating component heat exchanger 24 for the vehicle heat-generating component.

Switching from Maximum Cooling Mode to Cooling Mode

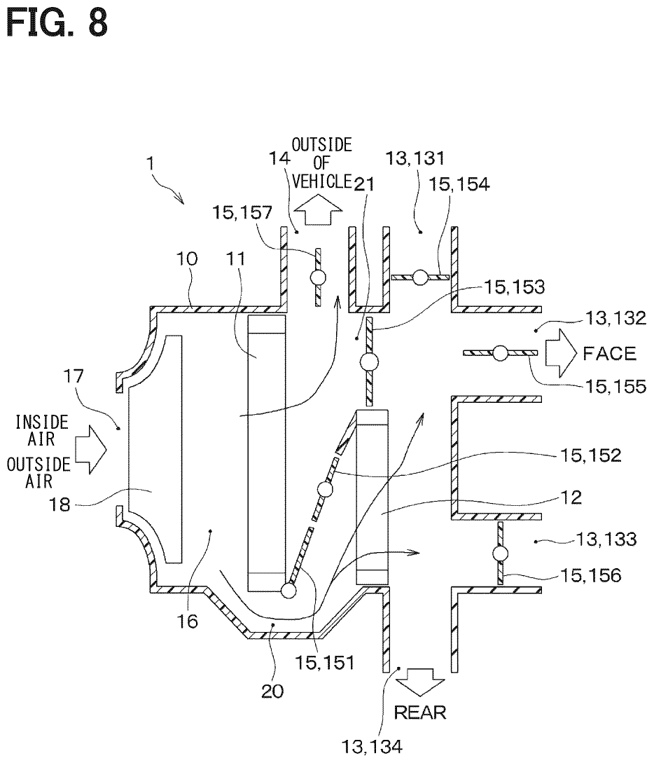

Control executed by the ECU 3 at the time of switching from the maximum cooling mode to the cooling mode will be described. As shown in FIG. 8, at the time of switching from the maximum cooling mode to the cooling mode, the ECU 3 temporarily shuts off the flow of the hot water through the first heat exchanger 11 in the maximum cooling mode. Specifically, the ECU 3 closes the first flow-rate control valve 43 and the second flow-rate control valve 44. Also, the ECU 3 drives the flow path switching valves 45-56 to switch to the flow of the low-temperature heat medium in the cooling mode shown in FIG. 2. Subsequently, the ECU 3 drives the air path switching mechanism 15 to set the state of the cooling mode shown in FIG. 1 after the temperature of the first heat exchanger 11 becomes lower than the temperature of the air on the upstream side of the first heat exchanger 11. Note that the state of the cooling mode is a state in which the air that has passed through both the first heat exchanger 11 and the second heat exchanger 12 flows to the outlet opening 13. This makes it possible to prevent the air at the high temperature from being blown out from the opening 13 into the vehicle cabin.

The vehicle heat pump system according to the first embodiment described above provides the following effects and advantages.

In the first embodiment, at the time of executing the maximum cooling mode, the ECU 3 drives each corresponding one of the components of the heat medium circuit 2 such that the first heat exchanger 11 performs the heat-releasing function, the second heat exchanger 12 performs the heat-absorbing function, and the external heat exchanger 23 performs the heat-releasing function, as shown in FIGS. 5 and 6. Furthermore, the ECU 3 drives the air path switching mechanism 15 such that the air, which has passed through first heat exchanger 11 without passing through the second heat exchanger 12, is discharged from the discharge opening 14 to outside the vehicle cabin, and the air, which has passed through the second heat exchanger 12 without passing through the first heat exchanger 11, is blown from the outlet opening 13 into the vehicle cabin.

According to this, by setting the first heat exchanger 11 and the external heat exchanger 23 to perform the heat-releasing function, it is possible to increase the amount of heat released from the heat medium in the heat medium circuit 2 to the substance outside the heat exchangers 11, 12 (i.e., the air discharged from the air conditioning case 10 to outside the vehicle cabin, and the air outside the vehicle cabin). Thus, the maximum performance of the vehicle heat pump system can be improved while supplying the cold air into the vehicle cabin via the second heat exchanger 12 to cool the vehicle cabin. At that time, this vehicle heat pump system discharges the air, which has passed through the first heat exchanger 11 without passing through the second heat exchanger 12, from the discharge opening 14 to outside the vehicle cabin. That is, this vehicle heat pump system does not perform the operation such as cooling the air through one of the heat exchangers and then heating it through the other one of the heat exchangers, as in the previously proposed system discussed above, so no energy loss occurs. As a result, this vehicle heat pump system improves efficiency over the configuration of the previously proposed system discussed above.
(2) In the first embodiment, at the time of executing the maximum heating mode, the ECU 3 drives each corresponding one of the components of the heat medium circuit 2 such that the first heat exchanger 11 performs the heat-absorbing function, the second heat exchanger 12 performs the heat-releasing function, and the external heat exchanger 23 performs the heat-absorbing function, as shown in FIGS. 7 and 4. Furthermore, the ECU 3 drives the air path switching mechanism 15 such that the air, which has passed through first heat exchanger 11 without passing through the second heat exchanger 12, is discharged from the discharge opening 14 to outside the vehicle cabin, and the air, which has passed through the second heat exchanger 12 without passing through the first heat exchanger 11, is blown from the outlet openings 13 into the vehicle cabin.

According to this, by setting the first heat exchanger 11 and the external heat exchanger 23 to the heat-absorbing function, it is possible to increase the amount of heat absorbed by the heat medium flowing through the heat medium circuit 2 from the air discharged from the air conditioning case 10 to outside the vehicle cabin and from the air outside the vehicle cabin. Thus, the maximum performance of the vehicle heat pump system can be improved while supplying the warm air into the vehicle cabin via the second heat exchanger 12 to heat the vehicle cabin. At that time, this vehicle heat pump system discharges the air, which has passed through the first heat exchanger 11 without passing through the second heat exchanger 12, from the discharge opening 14 to outside the vehicle cabin. That is, this vehicle heat pump system does not perform the operation such as cooling the air through one of the heat exchangers and then heating it through the other one of the heat exchangers, as in the previously proposed system discussed above, so no energy loss occurs. As a result, this vehicle heat pump system improves efficiency over the configuration of the previously proposed system discussed above.
(3) In the first embodiment, the heat medium circuit 2 is configured such that both the first heat exchanger 11 and the second heat exchanger 12 are switchable between the heat-releasing function and the heat-absorbing function.

According to this, by switching the functions of the first heat exchanger 11 and the second heat exchanger 12, it is possible to execute both the maximum cooling mode and the maximum heating mode by the air conditioning device 1 with the same configuration.
(4) In the first embodiment, at the time of switching from the maximum cooling mode to the cooling mode, the ECU 3 shuts off the flow of the hot water through the first heat exchanger 11 in the maximum cooling mode and switches to the flow of the cold water through the first heat exchanger 11 in the cooling mode. Then, after the temperature of the first heat exchanger 11 falls below the temperature of the air on the upstream side of the first heat exchanger 11, the ECU 3 drives the air path switching mechanism 15 such that the air, which has passed through both the first heat exchanger 11 and the second heat exchanger 12, flows to the outlet opening 13.

This prevents the air at the high temperature from being blown from the outlet opening 13 into the vehicle cabin at the time of switching from the maximum cooling mode to the cooling mode.
(5) In the first embodiment, the volume, which is obtained by multiplying the length, the width and the height of the outer shape of the one of the first heat exchanger 11 and the second heat exchanger 12, is larger than the volume, which is obtained by multiplying the length, the width and the height of the outer shape of the other one of the first heat exchanger 11 and the second heat exchanger 12.

According to this, the vehicle heat pump system can increase the heat-releasing capacity of the first heat exchanger 11 in the maximum cooling mode, thereby improving the maximum performance.

Furthermore, the vehicle heat pump system can increase the heat-absorbing capacity of the first heat exchanger 11 even in the maximum heating mode, thereby improving the maximum performance.
(6) In the first embodiment, the discharge opening 14 is disposed in the region downstream of the first heat exchanger 11 and upstream of the second heat exchanger 12.

According to this, by effectively utilizing the space between the first heat exchanger 11 and the second heat exchanger 12, it is possible to reduce the size of the air conditioning device 1. In particular, the size can be further reduced in the air conditioning device 1 of the reheat type as in the present embodiment.
(7) In the first embodiment, the heat medium circuit 2 includes the second flow-rate control valve 44 that is configured to adjust the flow rate or the temperature of the heat medium flowing inside the second heat exchanger 12.

According to this, it is possible to adjust the temperature of the conditioned air that passes through the second heat exchanger 12 and is blown from the outlet opening 13 into the vehicle cabin.
(8) In the first embodiment, the heat medium circuit 2 includes: the refrigeration cycle 30 that is configured to circulate the refrigerant as the first heat medium; and the coolant circuit 40 that is configured to circulate the coolant as the second heat medium. The first heat exchanger 11, the second heat exchanger 12 and the external heat exchanger 23 are disposed in the coolant circuit 40.

According to this, the configuration of the refrigeration cycle 30 can be simplified.
(9) In the first embodiment, at the time of executing the maximum cooling mode, the ECU 3 drives each corresponding one of the components of the heat medium circuit 2 such that the first heat exchanger 11 performs the heat-releasing function, the second heat exchanger 12 performs the heat-absorbing function, the external heat exchanger 23 performs the heat-releasing function, and the heat-generating component heat exchanger 24 performs the heat-absorbing function, as shown in FIGS. 5 and 6.

Thereby, while supplying the cold air to the vehicle cabin through the second heat exchanger 12 to perform the vehicle cabin cooling, the vehicle heat pump system can increase the cooling capacity of the heat-generating component heat exchanger 24 for the vehicle heat-generating component, thereby improving the maximum performance. Therefore, compared with the configuration of the previously proposed system discussed above, this vehicle heat pump system can improve the cooling efficiency of the vehicle cabin air conditioning and the cooling efficiency of the vehicle heat-generating component.
(10) At the time of executing the maximum heating mode, the ECU 3 drives each corresponding one of the components of the heat medium circuit 2 such that the first heat exchanger 11 performs the heat-absorbing function, the second heat exchanger 12 performs the heat-releasing function, the external heat exchanger 23 performs the heat-absorbing function, and the heat-generating component heat exchanger 24 performs the heat-releasing function, as shown in FIGS. 7 and 4.

Thereby, while supplying the warm air to the vehicle cabin through the second heat exchanger 12 to perform the vehicle cabin heating, the vehicle heat pump system can increase the heating capacity of the heat-generating component heat exchanger 24 for the vehicle heat-generating component, thereby improving the maximum performance. Therefore, compared with the configuration of the previously proposed system discussed above, this vehicle heat pump system can improve the heating efficiency of the vehicle cabin air conditioning and the heating efficiency of the vehicle heat-generating component.

### Second Embodiment

Next, the second embodiment will be described. The second embodiment is a modification of the first embodiment, in which the method of the cooling mode is modified from that of the first embodiment. Since the rest of the second embodiment is the same as that of the first embodiment, only the differences from the first embodiment will be described.

### Cooling Mode of Second Embodiment

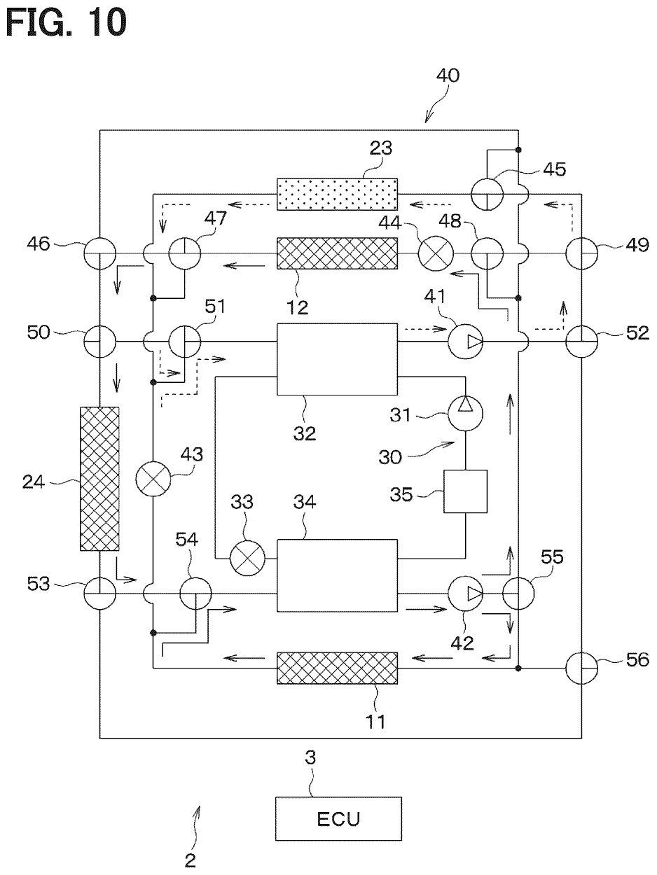

The cooling mode of the second embodiment will be described. As shown in FIGS. 9 and 10, in the cooling mode of the second embodiment, both the first heat exchanger 11 and the second heat exchanger 12 are set to perform the heat-absorbing function.

Specifically, at the time of executing the cooling mode, as shown in FIG. 9, the ECU 3 drives the first heat exchanger bypass door 151 to open the first heat exchanger bypass passage 20 and drives the cold air bypass door 153 to open the cold air bypass passage 21. The ECU 3 may set the switching door 152 to a state in which the flow of the air from the first heat exchanger 11 to the second heat exchanger 12 is blocked, as shown in FIG. 9, or, although not illustrated, the ECU 3 may set the switching door 152 to a state in which the flow of the air from the first heat exchanger 11 to the second heat exchanger 12 is permitted. The ECU 3 drives the discharge door 157 to close the discharge opening 14. The ECU 3 opens the door of the outlet opening 13 (e.g., the face door 155). Therefore, the air, which has passed through the first heat exchanger 11, and the air, which has passed through the second heat exchanger 12, are both blown from the outlet opening 13 into the vehicle cabin.

Also, the ECU 3 drives the compressor 31 and drives the flow path switching valves 45-56 such that the hot water and the cold water flow as indicated by the dotted line arrows and the solid line arrows in FIG. 10, and the ECU 3 closes the first flow-rate control valve 43 and opens the second flow-rate control valve 44. Therefore, the cold water flows through both the first heat exchanger 11 and the second heat exchanger 12, and the hot water flows through the external heat exchanger 23. Accordingly, the first heat exchanger 11 and the second heat exchanger 12 both perform the heat-absorbing function, and the external heat exchanger 23 performs the heat-releasing function. In addition, the cold water flows through the heat-generating component heat exchanger 24, which therefore performs the heat-absorbing function.

In the second embodiment described above, the ECU 3 can drive the heat medium circuit 2 such that both the first heat exchanger 11 and the second heat exchanger 12 perform the heat-absorbing function.

According to this, by making both the first heat exchanger 11 and the second heat exchanger 12 perform the heat-absorbing function, the vehicle cabin cooling capacity can be increased.

Alternatively, if the capacity at the time of using both the first heat exchanger 11 and the second heat exchanger 12 for cooling is equivalent to the capacity at the time of using only the first heat exchanger 11 for cooling as described in the cooling mode of the first embodiment, the configuration of the second embodiment allows the first heat exchanger 11 and the second heat exchanger 12 to be downsized. Therefore, in the second embodiment, the size of the air conditioning device 1 can be reduced.

### Third Embodiment

The third embodiment will be described. The third embodiment is a modification of the first embodiment, in which the method of the heating mode is modified from that of the first embodiment. Since the rest of the third embodiment is the same as that of the first embodiment, only the differences from the first embodiment will be described.

### Heating Mode of Third Embodiment

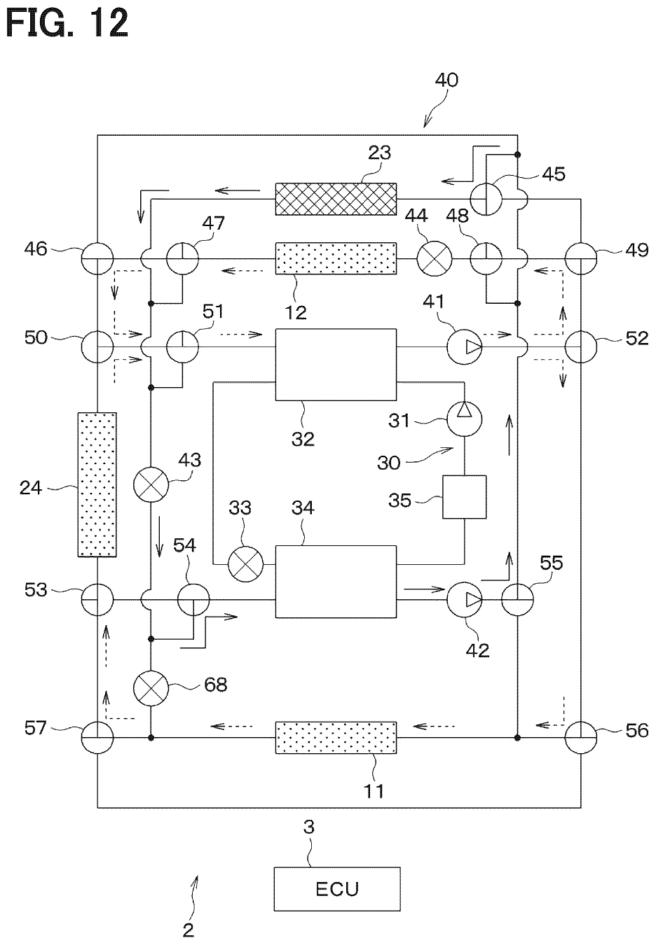

The heating mode of the third embodiment will be described. As shown in FIGS. 11 and 12, in the heating mode of the third embodiment, both the first heat exchanger 11 and the second heat exchanger 12 are set to perform the heat-releasing function.

Specifically, as shown in FIG. 11, at the time of executing the heating mode, the ECU 3 opens the doors of the outlet openings 13 (e.g., the defroster door 154, the face door 155 and the foot door 156) in contrast to the cooling mode described in the second embodiment. Therefore, the air, which has passed through the first heat exchanger 11, and the air, which has passed through the second heat exchanger 12, are both blown from the outlet openings 13 into the vehicle cabin.

Also, the ECU 3 drives the compressor 31 and drives the flow path switching valves 45-57 such that the hot water and the cold water flow as indicated by the dotted line arrows and the solid line arrows in FIG. 12, and the ECU 3 opens the first flow-rate control valve 43 and the second flow-rate control valve 44 and closes the third flow-rate control valve 68. Therefore, the hot water flows through both the first heat exchanger 11 and the second heat exchanger 12, and the cold water flows through the external heat exchanger 23. Accordingly, the first heat exchanger 11 and the second heat exchanger 12 both perform the heat-releasing function, and the external heat exchanger 23 performs the heat-absorbing function. In addition, the hot water flows through the heat-generating component heat exchanger 24, which therefore performs the heat-releasing function.

In the third embodiment described above, the ECU 3 can drive the heat medium circuit 2 such that both the first heat exchanger 11 and the second heat exchanger 12 perform the heat-releasing function.

According to this, by making both the first heat exchanger 11 and the second heat exchanger 12 perform the heat-releasing function, the vehicle cabin heating capacity can be increased.

Alternatively, if the capacity at the time of using both the first heat exchanger 11 and the second heat exchanger 12 for heating is equivalent to the capacity at the time of using only the first heat exchanger 11 for heating as described in the heating mode of the first embodiment, the configuration of the third embodiment allows the first heat exchanger 11 and the second heat exchanger 12 to be downsized. Therefore, in the third embodiment, the size of the air conditioning device 1 can be reduced.

### Fourth Embodiment

Next, the fourth embodiment will be described. The fourth embodiment is a modification of the first embodiment, in which, for example when no occupants are present, the method of the maximum cooling mode is modified from that of the first embodiment. Since the rest of the fourth embodiment is the same as that of the first embodiment, only the differences from the first embodiment will be described.

### Maximum Cooling Mode of Fourth Embodiment

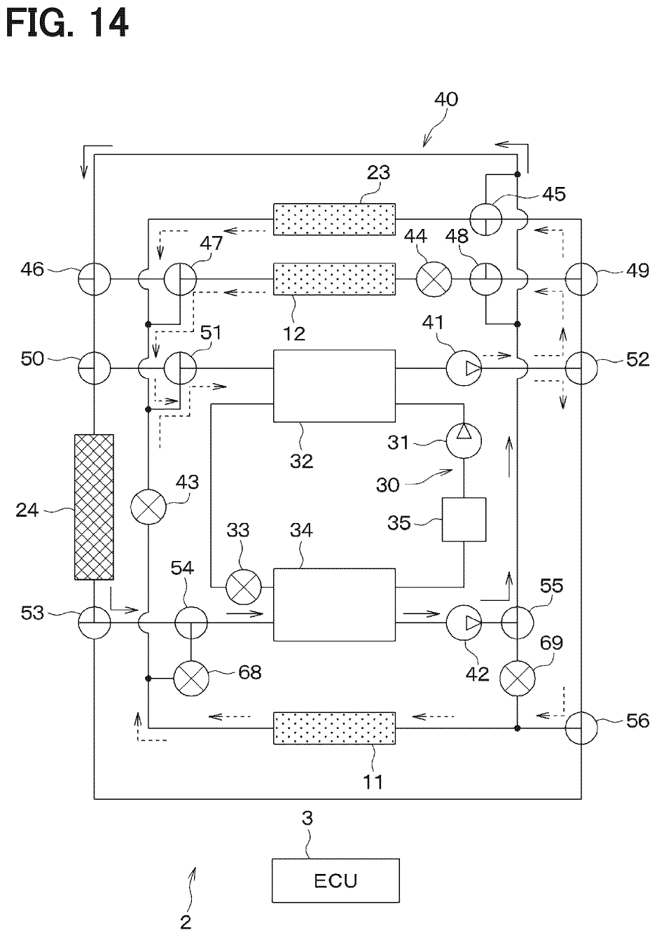

The maximum cooling mode of the fourth embodiment will be described. As shown in FIGS. 13 and 14, in the maximum cooling mode of the fourth embodiment, both the first heat exchanger 11 and the second heat exchanger 12 are set to perform the heat-releasing function.

Specifically, at the time of executing the maximum cooling mode, as shown in FIG. 13, the ECU 3 drives the first heat exchanger bypass door 151 to open the first heat exchanger bypass passage 20 and drives the cold air bypass door 153 to open the cold air bypass passage 21. The ECU 3 may set the switching door 152 to a state in which the flow of the air from the first heat exchanger 11 to the second heat exchanger 12 is blocked, as shown in FIG. 13, or, although not illustrated, the ECU 3 may set the switching door 152 to a state in which the flow of the air from the first heat exchanger 11 to the second heat exchanger 12 is permitted. The ECU 3 drives the discharge door 157 to open the discharge opening 14. The ECU 3 closes the defroster door 154, the face door 155 and the foot door 156, and also closes the rear passage 134 by a door, not shown. Therefore, the air, which has passed through the first heat exchanger 11, and the air, which has passed through the second heat exchanger 12, are both discharged from the discharge opening 14 to outside the vehicle cabin.

Also, the ECU 3 drives the compressor 31 and drives the flow path switching valves 45-56 such that the hot water and the cold water flow as indicated by the dotted line arrows and the solid line arrows in FIG. 14, and the ECU 3 opens the first flow-rate control valve 43 and the second flow-rate control valve 44 and closes the third flow-rate control valve 68 and the fourth flow-rate control valve 69. Therefore, the hot water flows through the first heat exchanger 11, the second heat exchanger 12 and the external heat exchanger 23. Accordingly, the first heat exchanger 11, the second heat exchanger 12 and the external heat exchanger 23 all perform the heat-releasing function. In contrast, the cold water flows through the heat-generating component heat exchanger 24, which therefore performs the heat-absorbing function.

In the fourth embodiment described above, the ECU 3 can drive the heat medium circuit 2 such that the first heat exchanger 11, the second heat exchanger 12 and the external heat exchanger 23 all perform the heat-releasing function. Furthermore, the ECU 3 can execute a second maximum cooling mode in which the ECU 3 drives the air path switching mechanism 15 such that the air, which has passed through the first heat exchanger 11, and the air, which has passed through the second heat exchanger 12, are discharged from the discharge opening 14 to outside the vehicle cabin.

According to this, in the heat medium circuit 2, it is possible to increase the cooling capacity for the heat-generating component by the heat-generating component heat exchanger 24. Therefore, it is possible to increase a cooling capacity for the battery as the example of the vehicle heat-generating component, thereby shortening a rapid charging time of the battery during the absence of the occupant. In addition, by drying the first heat exchanger 11 and the second heat exchanger 12, attachment of germs to the heat exchangers 11, 12 can be suppressed.

### Fifth Embodiment

Next, the fifth embodiment will be described. The fifth embodiment is a modification of the first embodiment, in which a method of a cabin heating and component heating mode is implemented in a case where frost or the like adheres to the external heat exchanger 23. Since the rest of the fifth embodiment is the same as that of the first embodiment, only the differences from the first embodiment will be described.

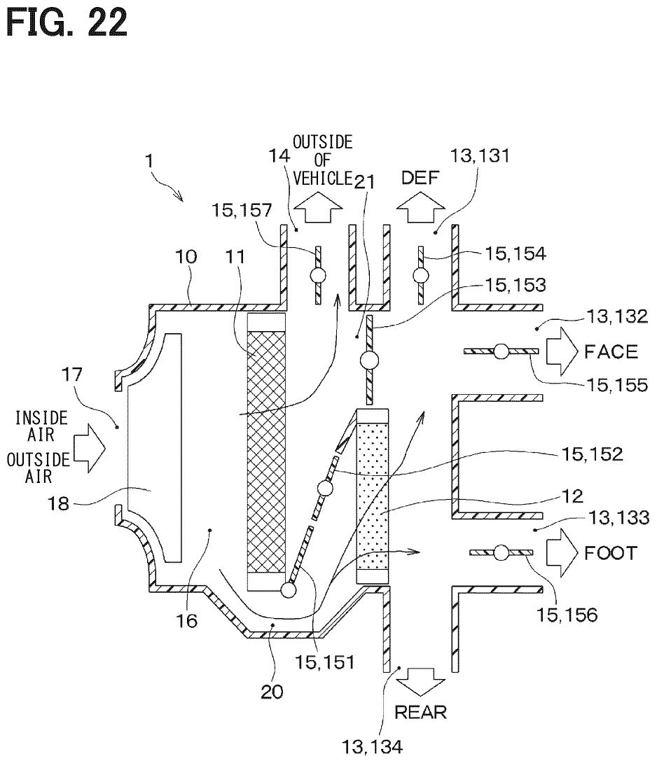

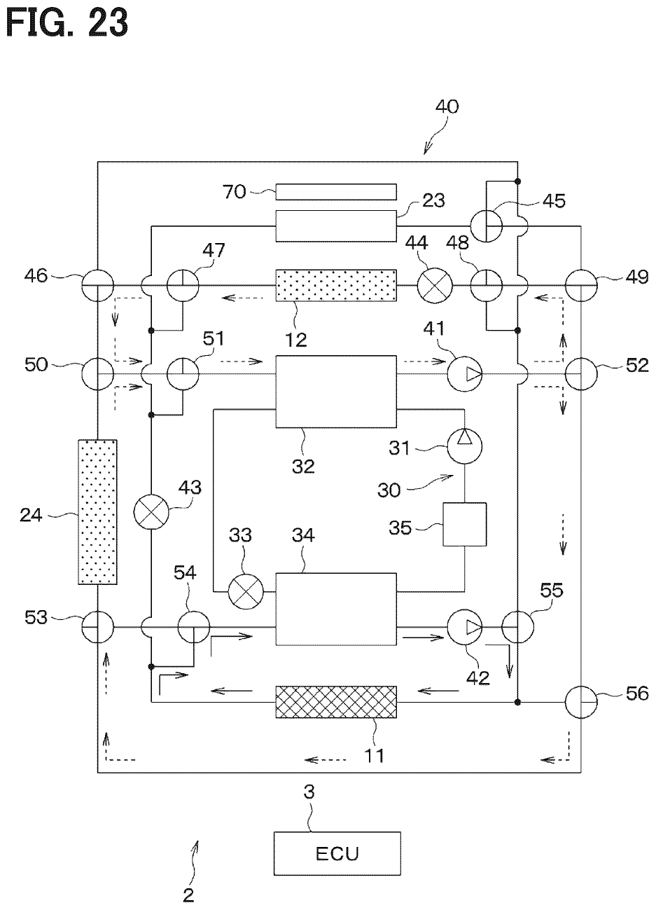

The fifth embodiment will be described with reference to FIGS. 22 and 23.

### Cabin Heating and Component Heating Mode in Case Where Frost or the Like Adheres to External Heat Exchanger 23

A cabin heating and component heating mode in a case where frost or the like adheres to the external heat exchanger 23, and thereby heat absorption from the outside air becomes difficult will be described. In this case, as shown in FIG. 22, the ECU 3 drives the air path switching mechanism 15 in the same manner as in the maximum heating mode described with reference to FIG. 7 of the first embodiment. Therefore, the air, which has passed through the first heat exchanger 11 without passing through the second heat exchanger 12, is discharged from the discharge opening 14 to outside the vehicle cabin. Furthermore, the air, which has passed through the second heat exchanger 12 without passing through the first heat exchanger 11, is blown from the outlet openings 13 into the vehicle cabin. Further, as shown in FIG. 23, an electric heater 70 is disposed adjacent to the external heat exchanger 23. The electric heater 70 heats the external heat exchanger 23 upon energization of the electric heater 70.

Also, the ECU 3 drives the compressor 31 and drives the flow path switching valves 45-56 such that the hot water and the cold water flow as indicated by the dotted line arrows and the solid line arrows in FIG. 23, and the ECU 3 opens the first flow-rate control valve 43 and the second flow-rate control valve 44. In addition, the ECU 3 drives the flow path switching valve 45 provided upstream of the external heat exchanger 23 so as to block the flow of the cold water to the external heat exchanger 23. As a result, the cold water flows through the first heat exchanger 11, and the hot water flows through the second heat exchanger 12. Furthermore, the hot water flows through the heat-generating component heat exchanger 24, and the cold water does not flow to the external heat exchanger 23. Accordingly, the first heat exchanger 11 performs the heat-absorbing function, and the second heat exchanger 12 and the heat-generating component heat exchanger 24 perform the heat-releasing function. Furthermore, the external heat exchanger 23 does not perform the heat-absorbing function and the heat-releasing function.

In the fifth embodiment described above, even if the frost or the like adheres to the external heat exchanger 23 and makes it difficult to maintain the heat absorption performance from the outside air, the electric heater 70 can melt the frost adhering to the external heat exchanger 23. In addition, in the fifth embodiment, the first heat exchanger 11 can absorb heat from the air flowing through the air passage 16 into the heat medium flowing in the first heat exchanger 11. Therefore, it is possible to heat the vehicle cabin and heat (e.g., warm up) the vehicle heat-generating component.

### Sixth Embodiment

Next, the sixth embodiment will be described. The sixth embodiment modifies parts of the configuration of the air conditioning device 1 and the heat medium circuit 2 relative to the first to fifth embodiments. Since the rest is the same as in the first through fifth embodiments, only the differences from the first to fifth embodiments will be described.

### Configuration of Air Conditioning Device 1

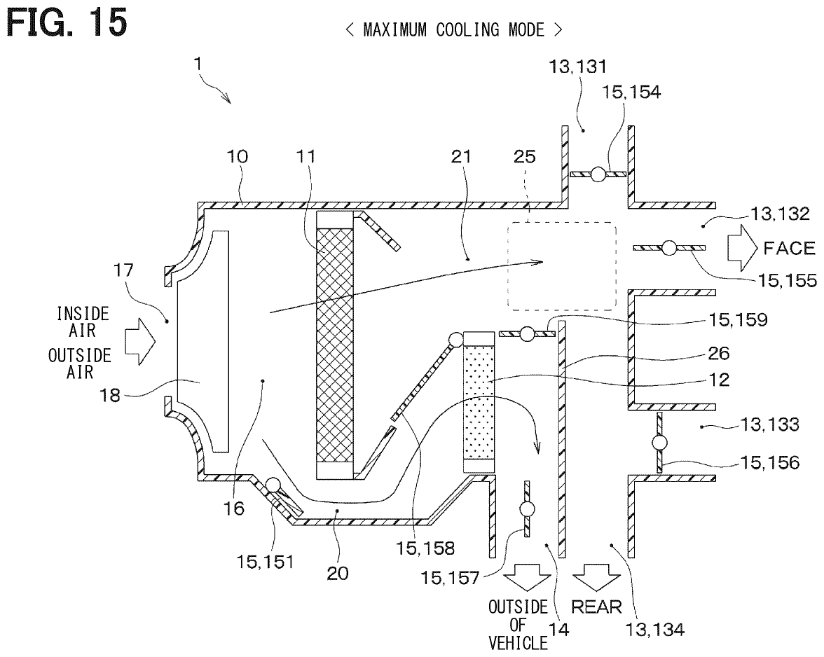

As shown in FIG. 15, the air conditioning device 1 of the sixth embodiment is of an air mix type. Inside the air conditioning case 10, an air mix region 25 is disposed in a region downstream of the cold air bypass passage 21 and upstream of the respective outlet openings 13. Note that in FIG. 15, the air mix region 25 is shown with a dotted line for explanatory purposes, but the air mix region 25 and the other regions form a continuous space. In the sixth embodiment, the discharge opening 14 and the outlet openings 13 are disposed downstream of the air mix region 25 in the air conditioning case 10. Furthermore, a partition wall 26 is formed between the discharge opening 14 and the outlet openings 13.

The air path switching mechanism 15 includes the first heat exchanger bypass door 151, an air mix door 158, a partition door 159, the discharge door 157, the defroster door 154, the face door 155 and the foot door 156.

As shown in FIG. 15, the air mix door 158 can direct the air, which has passed through the first heat exchanger 11, to the outlet opening 13 without passing through the second heat exchanger 12, and the air mix door 158 can direct the air, which has passed through the first heat exchanger bypass passage 20 without passing through the first heat exchanger 11, to the second heat exchanger 12. Although not illustrated, the air mix door 158 can allow the air, which has passed through the first heat exchanger 11, to pass through the second heat exchanger 12. Furthermore, by adjusting its opening degree, the air mix door 158 can regulate the flow rate of the air that passes through the first heat exchanger 11 while bypassing the second heat exchanger 12, as well as the flow rate of the air that passes through both the first heat exchanger 11 and the second heat exchanger 12. The partition door 159 can permit or block the flow of the air, which has passed through the second heat exchanger 12, into the air mix region 25.

The doors included in the air path switching mechanism 15 are not limited to plate doors shown in the drawings and may be various doors such as sliding doors, rotary doors, or film doors.

### Configuration of Heat Medium Circuit 2

Next, the configuration of the heat medium circuit 2 of the sixth embodiment will be described. The sixth embodiment is described such that the first heat exchanger 11 performs the heat-absorbing function, and the second heat exchanger 12 performs the heat-releasing function. The heat medium circuit 2 described below is one example of the present disclosure and does not limit the present disclosure.

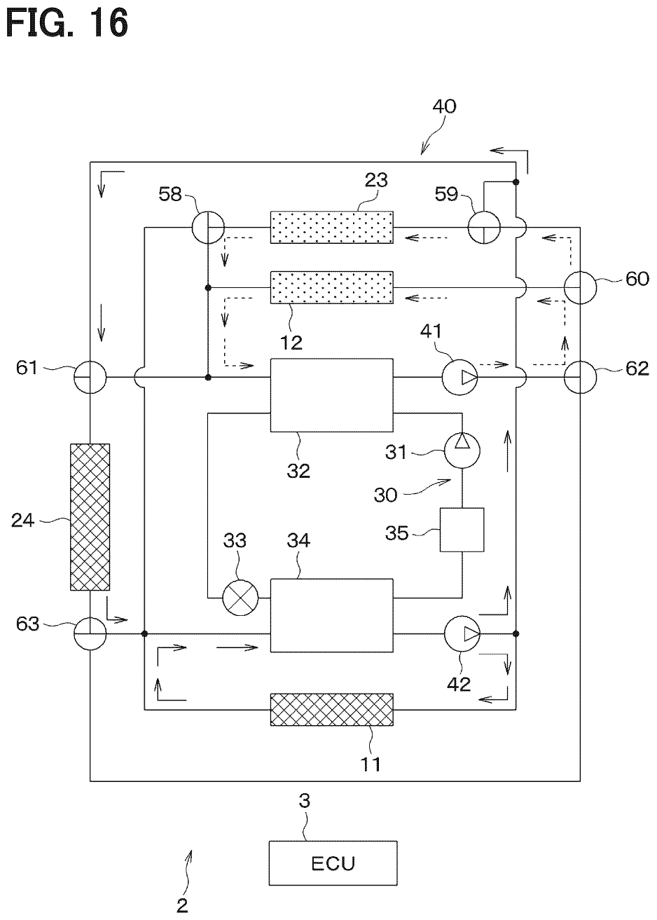

As shown in FIG. 16, the heat medium circuit 2 of the sixth embodiment includes: the refrigeration cycle 30 that is configured to circulate the refrigerant as the first heat medium; and the coolant circuit 40 that is configured to circulate the coolant as the second heat medium.

The coolant circuit 40 connects the first heat exchanger 11, the second heat exchanger 12, the external heat exchanger 23, the heat-generating component heat exchanger 24, the pumps 41, 42 and a plurality of flow path switching valves 58-63 together with the condenser 32 and the evaporator 34 of the refrigeration cycle 30 by the coolant piping through which the coolant flows. However, in the sixth embodiment, the first heat exchanger 11 and the second heat exchanger 12 do not switch between the heat-absorbing function and the heat-releasing function. The first heat exchanger 11 is fixed to the heat-absorbing function, and the second heat exchanger 12 is fixed to the heat-releasing function. Therefore, the heat medium circuit 2 of the sixth embodiment has a simpler configuration compared with the plurality of flow path switching valves 45-56 and the piping routing described in the first embodiment and the like. Specifically, in the coolant circuit 40 of the sixth embodiment, the number of the flow path switching valves 58-63 is smaller than that in the first embodiment and the like. In addition, the coolant circuit 40 of the sixth embodiment does not require the plurality of flow-rate control valves 43, 44 described for the first embodiment and the like.

### Maximum Cooling Mode

A maximum cooling mode will be described. As shown in FIG. 15, at the time of executing the maximum cooling mode, for example, when the outside air has a high temperature in summer or the like, the ECU 3 drives the air mix door 158 to block the flow of the air, which has passed through the first heat exchanger 11, to the second heat exchanger 12. The ECU 3 closes the partition door 159 and opens the door of the outlet opening 13 (e.g., the face door 155). Therefore, the air, which has passed through the first heat exchanger 11 without passing through the second heat exchanger 12, is blown from the outlet opening 13 into the vehicle cabin.

Furthermore, the ECU 3 drives the first heat exchanger bypass door 151 such that the air, which has passed through the first heat exchanger bypass passage 20, flows to the second heat exchanger 12. The ECU 3 closes the partition door 159 to block the flow of the air, which has passed through the second heat exchanger 12, into the air mix region 25, and the ECU 3 drives the discharge door 157 to open the discharge opening 14. Therefore, the air, which has passed through the second heat exchanger 12 without passing through the first heat exchanger 11, is discharged from the discharge opening 14 to outside the vehicle cabin.

Also, the ECU 3 drives the compressor 31 and drives the flow path switching valves 58-63 such that the hot water and the cold water flow as indicated by the dotted line arrows and the solid line arrows in FIG. 16. As a result, the cold water flows through the first heat exchanger 11, and the hot water flows through the second heat exchanger 12 and the external heat exchanger 23. Furthermore, the cold water flows through the heat-generating component heat exchanger 24. Accordingly, the first heat exchanger 11 performs the heat-absorbing function, and the second heat exchanger 12 and the external heat exchanger 23 perform the heat-releasing function. Furthermore, the heat-generating component heat exchanger 24 performs the heat-absorbing function.

Thus, since the air, which has passed through the second heat exchanger 12, is discharged from the discharge opening 14 to outside the vehicle cabin, the second heat exchanger 12 functions as a radiator, similar to the external heat exchanger 23, making it possible to increase the heat-releasing capacity of the heat medium circuit 2. Therefore, the cooling capacity of the heat-generating component heat exchanger 24 for the vehicle heat-generating component is increased, enabling maximum cooling of the vehicle heat-generating component. Furthermore, the first heat exchanger 11 performs the heat-absorbing function, and thereby cooling of the vehicle cabin can also be performed at the same time.

In the sixth embodiment described above, the first heat exchanger 11 and the second heat exchanger 12 do not switch between the heat-absorbing function and the heat-releasing function. The first heat exchanger 11 is fixed to the heat-absorbing function, and the second heat exchanger 12 is fixed to the heat-releasing function. Therefore, the heat medium circuit 2 of the sixth embodiment can be simplified compared with the heat medium circuit 2 described in the first embodiment and the like.

Furthermore, even in the sixth embodiment, neither the first heat exchanger 11 nor the second heat exchanger 12 performs the operation such as reheating the cooled air and discharging it outside the vehicle or recooling the heated air and discharging it outside the vehicle, as in the previously proposed system discussed above. Therefore, unnecessary energy loss does not occur in the heat medium circuit 2.

### Seventh Embodiment

Next, the seventh embodiment will be described. The seventh embodiment is a modification of the sixth embodiment, in which part of the configuration of the air conditioning device 1 is changed relative to that of the sixth embodiment. The rest of the seventh embodiment is the same as that of the sixth embodiment. Therefore, only the differences from the sixth embodiment will be described.

### Configuration of Air Conditioning Device 1

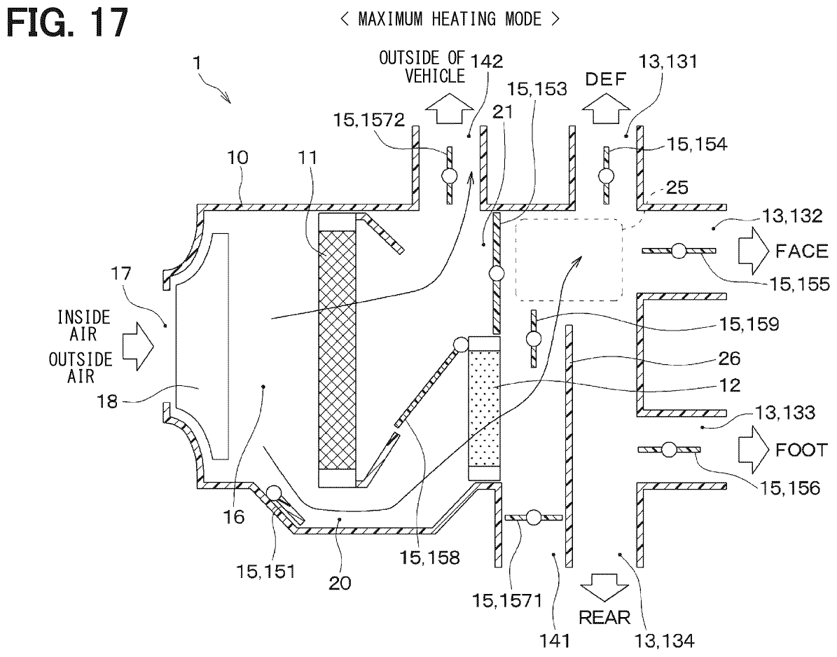

As shown in FIG. 17, in the air conditioning device 1 of the seventh embodiment, a second discharge opening 142 and a second discharge door 1572 are provided in a region downstream of the first heat exchanger 11 and upstream of the second heat exchanger 12 in the air conditioning case 10. The cold air bypass door 153 is provided in the cold air bypass passage 21. Note that in the seventh embodiment, the discharge opening 14 and the discharge door 157 disposed downstream of the second heat exchanger 12, as described in the sixth embodiment, are referred to as a first discharge opening 141 and a first discharge door 1571, respectively.

### Maximum Heating Mode

A maximum heating mode will be described. As shown in FIG. 17, at the time of executing the maximum heating mode, for example, when the outside air has a low temperature in winter or the like, the ECU 3 drives the air mix door 158 to block the flow of the air, which has passed through the first heat exchanger 11, to the second heat exchanger 12. The ECU 3 opens the second discharge door 1572 and closes the cold air bypass door 153. Therefore, the air, which has passed through the first heat exchanger 11 without passing through the second heat exchanger 12, is discharged from the second discharge opening 142 to outside the vehicle cabin.

Furthermore, the ECU 3 drives the first heat exchanger bypass door 151 such that the air, which has passed through the first heat exchanger bypass passage 20, flows to the second heat exchanger 12. The ECU 3 closes the first discharge door 1571 and opens the partition door 159 and the doors of the outlet openings 13. Therefore, the air, which has passed through the first heat exchanger bypass passage 20 and the second heat exchanger 12 without passing through the first heat exchanger 11, is blown from the outlet openings 13 into the vehicle cabin.

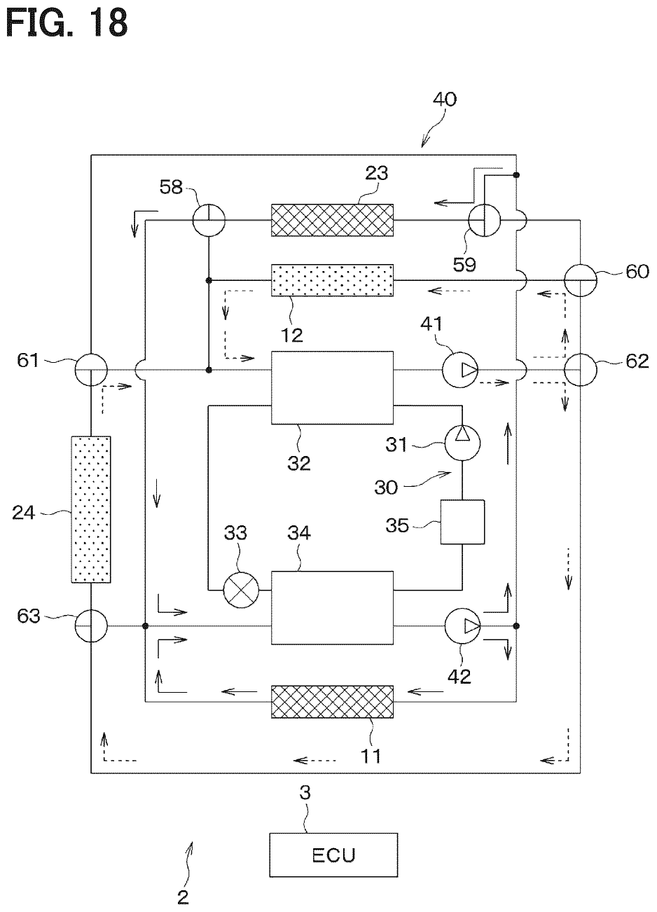

Also, the ECU 3 drives the compressor 31 and drives the flow path switching valves 58-63 such that the hot water and the cold water flow as indicated by the dotted line arrows and the solid line arrows in FIG. 18. As a result, the cold water flows through the first heat exchanger 11 and the external heat exchanger 23, and the hot water flows through the second heat exchanger 12 and the heat-generating component heat exchanger 24. Accordingly, the first heat exchanger 11 and the external heat exchanger 23 perform the heat-absorbing function, and the second heat exchanger 12 and the heat-generating component heat exchanger 24 perform the heat-releasing function.

Thus, since the air, which has passed through the first heat exchanger 11, is discharged from the second discharge opening 142 to outside the vehicle cabin, the first heat exchanger 11 functions as a heat absorber like the external heat exchanger 23, making it possible to increase the heat-absorbing capacity of the heat medium circuit 2. Therefore, the heating capacity of the heat-generating component heat exchanger 24 for the vehicle heat-generating component is increased, enabling maximum heating (e.g., warm-up) of the vehicle heat-generating component.

Furthermore, the second heat exchanger 12 performs the heat-releasing function, and thereby heating of the vehicle cabin can also be performed at the same time. In the vehicle cabin heating, a blowout temperature of the air can be adjusted by adjustment of the opening degree of the air mix door 158.

In the seventh embodiment described above, the first heat exchanger 11 and the second heat exchanger 12 do not switch between the heat-absorbing function and the heat-releasing function. The first heat exchanger 11 is fixed to the heat-absorbing function, and the second heat exchanger 12 is fixed to the heat-releasing function. Therefore, the heat medium circuit 2 of the seventh embodiment can be simplified compared with the heat medium circuit 2 described in the first embodiment and the like.

Furthermore, even in the seventh embodiment, neither the first heat exchanger 11 nor the second heat exchanger 12 performs the operation such as reheating the cooled air and discharging it outside the vehicle or recooling the heated air and discharging it outside the vehicle, as in the previously proposed system discussed above. Therefore, unnecessary energy loss does not occur in the heat medium circuit 2.

### Eighth Embodiment

Next, the eighth embodiment will be described. The eighth embodiment is a modification of the first to seventh embodiments, in which the configuration of the heat medium circuit 2 is changed from that of the first to seventh embodiments, and the rest of the eighth embodiment is the same as that of the first to seventh embodiments. Therefore, only the differences from the first to seventh embodiments will be described.

### Configuration of Heat Medium Circuit 2

Next, the configuration of the heat medium circuit 2 of the eighth embodiment will be described. The heat medium circuit 2 described below is one example of the present disclosure and does not limit the present disclosure.

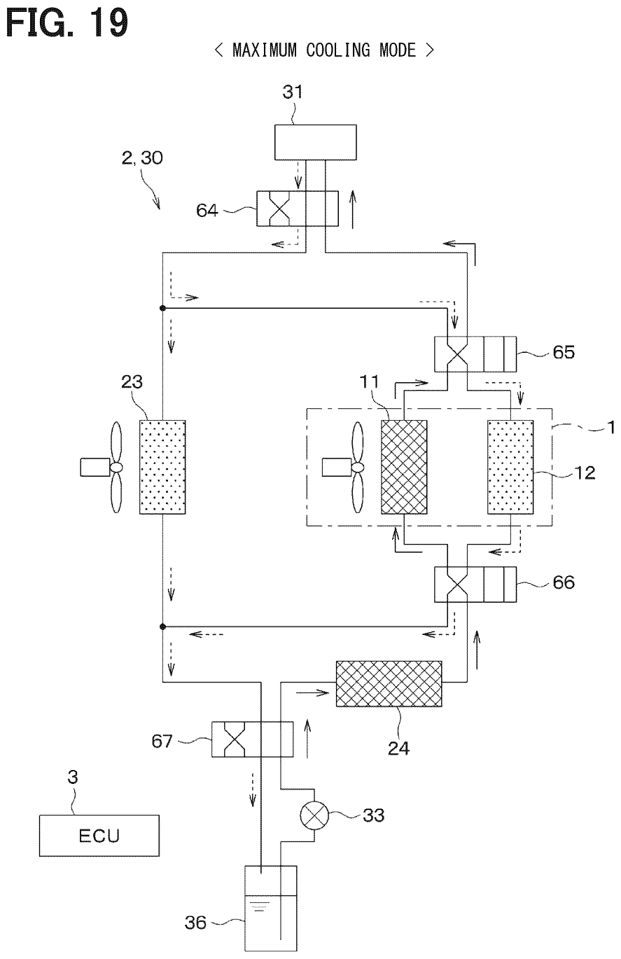

As shown in FIG. 19, in the heat medium circuit 2 of the eighth embodiment, the first heat exchanger 11, the second heat exchanger 12, the external heat exchanger 23 and the heat-generating component heat exchanger 24 are disposed in the refrigerant piping of the refrigeration cycle 30. The refrigeration cycle 30 has a configuration in which, in addition to the heat exchangers 11, 12, 23, 24 described above, the compressor 31, the expansion valve 33, a receiver 36, and a plurality of flow path switching valves 64-67 are connected by the refrigerant piping. The flow path switching valves 64-67 are, for example, four-way valves. Each of the first heat exchanger 11, the second heat exchanger 12, the external heat exchanger 23 and the heat-generating component heat exchanger 24 can be switched between the heat-releasing function and the heat-absorbing function for use.

### Maximum Cooling Mode

A maximum cooling mode will be described. As shown in FIG. 19, the ECU 3 drives the compressor 31 and drives the flow path switching valves 64-67 such that the refrigerant flows as indicated by the dotted line arrows and the solid line arrows in FIG. 19. Specifically, the refrigerant at a high-temperature and high-pressure discharged from the compressor 31 flows through the external heat exchanger 23 and the second heat exchanger 12 and is condensed and then flows into the receiver 36. Thereafter, the refrigerant, which flows out of the receiver 36, passes through the expansion valve 33 to become a gas-liquid two-phase refrigerant at a low temperature and low pressure, and then flows through the heat-generating component heat exchanger 24 and the first heat exchanger 11, where it becomes a gas-phase refrigerant and is drawn into the compressor 31. Therefore, the refrigerant at the low temperature and low pressure flows through the first heat exchanger 11 and the heat-generating component heat exchanger 24, and the refrigerant at the high temperature and high pressure flows through the second heat exchanger 12 and the external heat exchanger 23. Accordingly, the first heat exchanger 11 and the heat-generating component heat exchanger 24 perform the heat-absorbing function, and the second heat exchanger 12 and the external heat exchanger 23 perform the heat-releasing function. As discussed with reference to FIG. 15, the air conditioning device 1 discharges the air, which has passed through the second heat exchanger 12, to outside the vehicle, and the air conditioning device 1 supplies the air, which has passed through the first heat exchanger 11, into the vehicle cabin. As a result, cooling of the vehicle heat-generating components and cooling of the vehicle cabin can be performed.

### Maximum Heating Mode

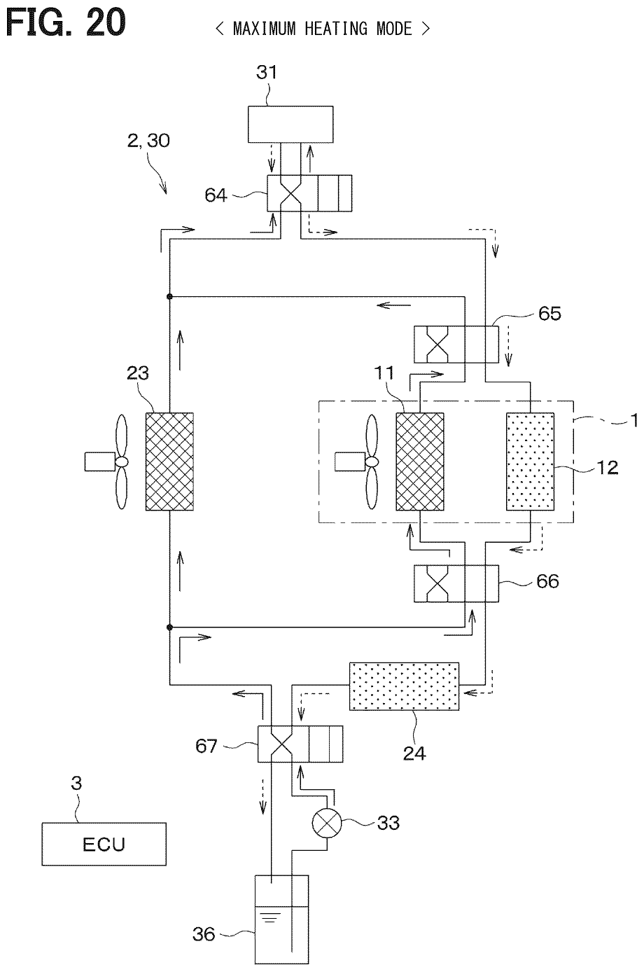

A maximum heating mode will be described. As shown in FIG. 20, the ECU 3 drives the compressor 31 and drives the flow path switching valves 64-67 such that the refrigerant flows as indicated by the dotted line arrows and the solid line arrows in FIG. 20. Specifically, the refrigerant at a high-temperature and high-pressure discharged from the compressor 31 flows through the second heat exchanger 12 and the heat-generating component heat exchanger 24 and is condensed and then flows into the receiver 36. Thereafter, the refrigerant, which flows out of the receiver 36, passes through the expansion valve 33 to become a gas-liquid two-phase refrigerant at a low-temperature and low-pressure, and then flows through the external heat exchanger 23 and the first heat exchanger 11, where it becomes a gas-phase refrigerant and is drawn into the compressor 31. Therefore, the refrigerant at the low temperature and low pressure flows through the first heat exchanger 11 and the external heat exchanger 23, and the refrigerant at the high temperature and high pressure flows through the second heat exchanger 12 and the heat-generating component heat exchanger 24. Accordingly, the first heat exchanger 11 and the external heat exchanger 23 perform the heat-absorbing function, and the second heat exchanger 12 and the heat-generating component heat exchanger 24 perform the heat-releasing function. As discussed with reference to FIG. 17, the air conditioning device 1 discharges the air, which has passed through the first heat exchanger 11, to outside the vehicle, and the air conditioning device 1 supplies the air, which has passed through the second heat exchanger 12, into the vehicle cabin. As a result, heating of the vehicle heat-generating components and heating of the vehicle cabin can be performed.

Note that, in the heat medium circuit 2 of the eighth embodiment, by driving two flow path switching valves 65, 66, each of which is provided at corresponding two ends of the first heat exchanger 11 and the second heat exchanger 12, the functions of the first heat exchanger 11 and the second heat exchanger 12 can be switched. That is, in the maximum cooling mode, it is also possible to make the first heat exchanger 11 have the heat-releasing function and the second heat exchanger 12 have the heat-absorbing function. In addition, in the maximum heating mode, it is also possible to make the first heat exchanger 11 have the heat-absorbing function and the second heat exchanger 12 have the heat-releasing function.

### Ninth Embodiment

Next, the ninth embodiment will be described. The ninth embodiment is a modification of the first to eighth embodiments, in which the configuration of the heat medium circuit 2 is changed from that of the first to eighth embodiments, and the rest of the ninth embodiment is the same as that of the first to eighth embodiments. Therefore, only the differences from the first to eighth embodiments will be described.

### Configuration of Heat Medium Circuit 2

Next, the configuration of the heat medium circuit 2 of the ninth embodiment will be described. The heat medium circuit 2 described below is one example of the present disclosure and does not limit the present disclosure.

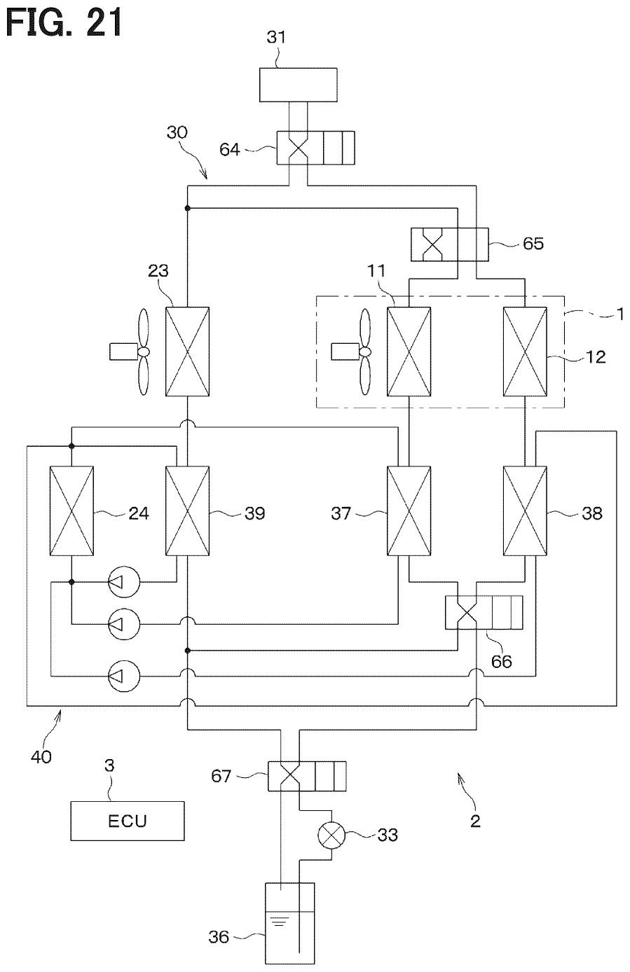

As shown in FIG. 21, in the heat medium circuit 2 of the ninth embodiment, the first heat exchanger 11, the second heat exchanger 12 and the external heat exchanger 23 are disposed in the refrigerant piping of the refrigeration cycle 30, and the heat-generating component heat exchanger 24 is disposed in the coolant circuit 40. Note that, in addition to the first heat exchanger 11, the second heat exchanger 12 and the external heat exchanger 23, the refrigeration cycle 30 includes a plurality of refrigerant-coolant heat exchangers 37-39 configured to perform heat exchange between the refrigerant flowing through the refrigeration cycle 30 and the coolant flowing through the coolant circuit 40.

As in the ninth embodiment described above, it is possible to configure the first heat exchanger 11, the second heat exchanger 12 and the external heat exchanger 23 as the condenser 32 or the evaporator 34 provided in the refrigeration cycle 30, and to configure the heat-generating component heat exchanger 24 as a heat exchanger provided in the coolant circuit 40. That is, each of the first heat exchanger 11, the second heat exchanger 12, the external heat exchanger 23 and the heat-generating component heat exchanger 24 can be configured either as a heat exchanger provided in the coolant circuit 40, or as the condenser 32 or the evaporator 34 provided in the refrigeration cycle 30.

### Other Embodiments

(1) In the heat medium circuit 2 described in the first to fifth embodiments, the configuration in which each pipe of the piping is connected using the three-way valve as the flow path switching valve is employed. However, the present disclosure is not limited thereto, and, for example, a configuration in which each pipe is connected using a multi-way valve such as a four-way valve or a five-way valve may be employed. In that case, the configuration of the piping can be simplified.
(2) In the sixth and seventh embodiments, the first heat exchanger 11 has been described as performing the heat-absorbing function, and the second heat exchanger 12 has been described as performing the heat-releasing function. However, the present disclosure is not limited thereto, and, for example, the first heat exchanger 11 may perform the heat-releasing function, and the second heat exchanger 12 may perform the heat-absorbing function. Further, also in the sixth and seventh embodiments, the heat medium circuit 2 may be configured such that the first heat exchanger 11 and the second heat exchanger 12 can be arbitrarily switched between the heat-releasing function and the heat-absorbing function for use.

The present disclosure is not limited to the embodiments described above, and the embodiments described above may be appropriately modified. Further, the embodiments described above are not unrelated to each other and can be appropriately combined unless the combination is clearly impossible. Needless to say, in each of the embodiments described above, the elements of the embodiment are not necessarily essential except when it is clearly indicated that they are essential and when they are clearly considered to be essential in principle. In each of the embodiments described above, when a numerical value such as the number, numerical value, amount, range or the like of the constituent elements of the embodiment is mentioned, the present disclosure should not be limited to such a numerical value unless it is clearly stated that it is essential and/or it is required in principle. In each of the embodiments described above, when the shape, the positional relationship or the like of the constituent elements of the embodiment are mentioned, the present disclosure should not be limited to the shape, the positional relationship or the like unless it is clearly stated that it is essential and/or it is required in principle.

The controller and its control method of the present disclosure may be realized by a dedicated computer that is provided by configuring at least one processor and a memory programmed to perform one or more functions embodied by a computer program. Alternatively, the controller and its control method of the present disclosure may be realized by a dedicated computer that is provided by configuring at least one processor with one or more dedicated hardware logic circuits. Further alternatively, the controller and its control method of the present disclosure may be realized by one or more dedicated computers that are provided by configuring a combination of: a processor programmed to perform one or more functions and a memory; and a processor composed of one or more hardware logic circuits. Further, the computer program may also be stored in a computer-readable, non-transitory, tangible storage medium as instructions to be executed by a computer. The memory described above is a non-transitory tangible storage medium. In the present disclosure or the claims, the phrase “at least one of a circuit and a processor” should be interpreted disjunctively (logical OR) and should not be interpreted as at least one circuit and at least one processor.

1. A heat pump system for a vehicle, the heat pump system comprising:
an air conditioning case that has an air passage which is configured to conduct air drawn from outside a vehicle cabin and air drawn from inside the vehicle cabin;
a first heat exchanger that is disposed in the air passage of the air conditioning case and is configured to exchange heat between the air flowing in the air passage and a heat medium;
a second heat exchanger that is disposed downstream of the first heat exchanger in the air passage of the air conditioning case and is configured to exchange heat between the air flowing in the air passage and the heat medium;
an outlet opening that is disposed downstream of the first heat exchanger and the second heat exchanger in the air conditioning case and is configured to blow the air from the air passage into the vehicle cabin;
a discharge opening that is disposed downstream of the first heat exchanger in the air conditioning case and is configured to discharge the air from the air passage to outside the vehicle cabin;
an air path switching mechanism that is configured to switch, within the air passage, a flow path of the air between (i) a state in which the air flowing in the air passage flows through the first heat exchanger without passing through the second heat exchanger toward the outlet opening or the discharge opening, and (ii) a state in which the air flowing in the air passage flows through the second heat exchanger without passing through the first heat exchanger toward the outlet opening or the discharge opening;
an external heat exchanger that is disposed in a space outside the air conditioning case and is configured to exchange heat between the air outside the vehicle cabin and the heat medium;
a heat medium circuit that connects the first heat exchanger, the second heat exchanger and the external heat exchanger by piping through which the heat medium flows, wherein the heat medium circuit includes a plurality of flow path switching valves, each of which is disposed in the piping and is configured to switch a flow of the heat medium; and
an electronic controller that includes at least one of (i) a circuit and (ii) a processor with a memory storing computer program code executable by the processor, wherein the electronic controller is configured to control operation of the air path switching mechanism and components of the heat medium circuit, which include the plurality of flow path switching valves, wherein:
for each heat exchanger, a heat-releasing function is defined as a function of releasing heat from the heat medium flowing inside the heat exchanger to a substance outside the heat exchanger, and a heat-absorbing function is defined as a function of absorbing heat from the substance outside the heat exchanger into the heat medium flowing inside the heat exchanger;
the electronic controller is configured to execute a maximum cooling mode, in which the electronic controller drives each corresponding one of the components of the heat medium circuit such that one of the first heat exchanger and the second heat exchanger performs the heat-releasing function, another one of the first heat exchanger and the second heat exchanger performs the heat-absorbing function, and the external heat exchanger performs the heat-releasing function, and the electronic controller drives the air path switching mechanism such that the air, which has passed through the one of the first heat exchanger and the second heat exchanger without passing through the another one of the first heat exchanger and the second heat exchanger, is discharged from the discharge opening to outside the vehicle cabin, and the air, which has passed through the another one of the first heat exchanger and the second heat exchanger without passing through the one of the first heat exchanger and the second heat exchanger, is blown from the outlet opening into the vehicle cabin; and
the electronic controller is configured to execute a maximum heating mode, in which the electronic controller drives each corresponding one of the components of the heat medium circuit such that a heat-absorbing one of the first heat exchanger and the second heat exchanger performs the heat-absorbing function, a heat-releasing one of the first heat exchanger and the second heat exchanger performs the heat-releasing function, and the external heat exchanger performs the heat-absorbing function, and the electronic controller drives the air path switching mechanism such that the air, which has passed through the heat-absorbing one of the first heat exchanger and the second heat exchanger without passing through the heat-releasing one of the first heat exchanger and the second heat exchanger, is discharged from the discharge opening to outside the vehicle cabin, and the air, which has passed through the heat-releasing one of the first heat exchanger and the second heat exchanger without passing through the heat-absorbing one of the first heat exchanger and the second heat exchanger, is blown from the outlet opening into the vehicle cabin.

2. The heat pump system according to claim 1, wherein the heat medium circuit is configured such that the first heat exchanger and the second heat exchanger are each switchable between the heat-releasing function and the heat-absorbing function.

3. The heat pump system according to claim 1, wherein:
the air path switching mechanism is configured to switch, within the air passage, the flow path of the air to a state in which the air flowing in the air passage passes through both the first heat exchanger and the second heat exchanger and flows to the outlet opening or the discharge opening;
the electronic controller is configured to execute a cooling mode in which the electronic controller drives each corresponding one of the components of the heat medium circuit such that a heat-absorbing one of the first heat exchanger and the second heat exchanger performs the heat-absorbing function, a remaining one of the first heat exchanger and the second heat exchanger has a flow of the heat medium therethrough shut off or performs the heat-absorbing function, and the external heat exchanger performs the heat-releasing function, and the electronic controller drives the air path switching mechanism such that the air, which has passed through both the first heat exchanger and the second heat exchanger, is blown from the outlet opening into the vehicle cabin; and
at a time of switching from the maximum cooling mode to the cooling mode, the electronic controller shuts off, in the maximum cooling mode, a flow of the heat medium at a high temperature through the one of the first heat exchanger and the second heat exchanger, which performs the heat-releasing function during the maximum cooling mode, and switches the flow being shut off to a flow of the heat medium at a low temperature for the cooling mode in the one of the first heat exchanger and the second heat exchanger, and, after a temperature of the one of the first heat exchanger and the second heat exchanger, through which the flow of the heat medium at the high temperature has been shut off, falls below a temperature of the air on an upstream side of the one of the first heat exchanger and the second heat exchanger, through which the flow of the heat medium at the high temperature has been shut off, the electronic controller drives the air path switching mechanism to a state where the air, which has passed through both the first heat exchanger and the second heat exchanger, is directed to the outlet opening.

4. The heat pump system according to claim 1, wherein a volume of the first heat exchanger, which is obtained by multiplying a length, a width and a height of an outer shape of the first heat exchanger, is larger than a volume of the second heat exchanger, which is obtained by multiplying a length, a width and a height of an outer shape of the second heat exchanger.

5. The heat pump system according to claim 1, wherein the discharge opening is disposed in a region downstream of the first heat exchanger and upstream of the second heat exchanger.

6. The heat pump system according to claim 1, wherein:
the heat medium circuit is configured such that the first heat exchanger and the second heat exchanger are each switchable between the heat-releasing function and the heat-absorbing function; and
the electronic controller is configured to drive the heat medium circuit such that both the first heat exchanger and the second heat exchanger perform the heat-releasing function, and the electronic controller is further configured to drive the heat medium circuit such that both the first heat exchanger and the second heat exchanger perform the heat-absorbing function.

7. The heat pump system according to claim 1, wherein the heat medium circuit includes a flow-rate control valve that is configured to adjust a flow rate or a temperature of the heat medium flowing inside the second heat exchanger.

8. The heat pump system according to claim 1, further comprising a heat-generating component heat exchanger that is configured to exchange heat between a heat-generating component mounted on the vehicle and the heat medium, wherein:
the heat medium circuit connects the first heat exchanger, the second heat exchanger, the external heat exchanger and the heat-generating component heat exchanger by the piping which is configured to conduct the heat medium; and
at a time of executing the maximum cooling mode, the electronic controller drives each corresponding one of the components of the heat medium circuit such that the one of the first heat exchanger and the second heat exchanger performs the heat-releasing function, the another one of the first heat exchanger and the second heat exchanger performs the heat-absorbing function, the external heat exchanger performs the heat-releasing function, and the heat-generating component heat exchanger performs the heat-absorbing function.

9. The heat pump system according to claim 1, further comprising a heat-generating component heat exchanger that is configured to exchange heat between a heat-generating component mounted on the vehicle and the heat medium, wherein:
the heat medium circuit connects the first heat exchanger, the second heat exchanger, the external heat exchanger and the heat-generating component heat exchanger by the piping which is configured to conduct the heat medium; and
at a time of executing the maximum heating mode, the electronic controller drives each corresponding one of the components of the heat medium circuit such that the heat-absorbing one of the first heat exchanger and the second heat exchanger performs the heat-absorbing function, the heat-releasing one of the first heat exchanger and the second heat exchanger performs the heat-releasing function, the external heat exchanger performs the heat-absorbing function, and the heat-generating component heat exchanger performs the heat-releasing function.

10. The heat pump system according to claim 1, wherein:
the heat medium circuit includes:
a refrigeration cycle that is configured to circulate a refrigerant as a first heat medium; and
a coolant circuit that is configured to circulate a coolant as a second heat medium;
the refrigeration cycle includes:
a compressor that is configured to compress and discharge the refrigerant;
a condenser that is configured to heat the coolant flowing through the coolant circuit and condense the refrigerant by heat exchange between the coolant and the refrigerant;
an expansion valve that is configured to depressurize and expand the refrigerant condensed in the condenser; and
an evaporator that is configured to cool the coolant flowing through the coolant circuit and evaporate the refrigerant by heat exchange between the refrigerant and the coolant flowing through the coolant circuit, wherein the compressor, the condenser, the expansion valve and the evaporator are connected by refrigerant piping which is configured to conduct the refrigerant; and
each of the first heat exchanger, the second heat exchanger and the external heat exchanger is a heat exchanger disposed in the coolant circuit.

11. The heat pump system according to claim 1, wherein:
the heat medium circuit includes a refrigeration cycle that is configured to circulate a refrigerant as the heat medium;
the refrigeration cycle includes:
a compressor that is configured to compress and discharge the refrigerant;
a condenser that is configured to heat the air and condense the refrigerant by heat exchange between the air and the refrigerant;
an expansion valve that is configured to depressurize and expand the refrigerant condensed in the condenser;
an evaporator that is configured to cool the air and evaporate the refrigerant by heat exchange between the air and the refrigerant; and
the plurality of flow path switching valves, each of which is disposed in the piping and is configured to switch the flow of the refrigerant; and
each of the first heat exchanger, the second heat exchanger and the external heat exchanger functions as the condenser or the evaporator of the refrigeration cycle.

12. The heat pump system according to claim 1, wherein:
the heat medium circuit includes:
a refrigeration cycle that is configured to circulate a refrigerant as a first heat medium; and
a coolant circuit that is configured to circulate a coolant as a second heat medium;
the refrigeration cycle includes:
a compressor that is configured to compress and discharge the refrigerant;
a condenser that is configured to heat one of the coolant flowing through the coolant circuit and the air and condense the refrigerant by heat exchange between the refrigerant and the one of the coolant and the air;
an expansion valve that is configured to depressurize and expand the refrigerant condensed in the condenser;
an evaporator that is configured to cool the one of the coolant flowing through the coolant circuit and the air and evaporate the refrigerant by heat exchange between the refrigerant and the one of the coolant and the air; and
the plurality of flow path switching valves, each of which is disposed in the piping and is configured to switch the flow of the refrigerant; and
each of the first heat exchanger, the second heat exchanger and the external heat exchanger functions as the condenser of the refrigeration cycle, the evaporator of the refrigeration cycle or a heat exchanger of the coolant circuit.

13. The heat pump system according to claim 1, wherein:
the maximum cooling mode is defined as a first maximum cooling mode; and
the electronic controller is configured to execute a second maximum cooling mode in which the electronic controller drives each corresponding one of the components of the heat medium circuit such that the first heat exchanger, the second heat exchanger and the external heat exchanger all perform the heat-releasing function, and the electronic controller drives the air path switching mechanism so as to discharge the air that has passed through the first heat exchanger and the air that has passed through the second heat exchanger to outside the vehicle cabin through the discharge opening.

14. A heat pump system for a vehicle, the heat pump system comprising:
an air conditioning case that has an air passage which is configured to conduct air drawn from outside a vehicle cabin and air drawn from inside the vehicle cabin;
a first heat exchanger that is disposed in the air passage of the air conditioning case and is configured to exchange heat between the air flowing in the air passage and a heat medium;
a second heat exchanger that is disposed downstream of the first heat exchanger in the air passage of the air conditioning case and is configured to exchange heat between the air flowing in the air passage and the heat medium;
an outlet opening that is disposed downstream of the first heat exchanger and the second heat exchanger in the air conditioning case and is configured to blow the air from the air passage into the vehicle cabin;
a discharge opening that is disposed downstream of the first heat exchanger in the air conditioning case and is configured to discharge the air from the air passage to outside the vehicle cabin;
an air path switching mechanism that is configured to switch, within the air passage, a flow path of the air between (i) a state in which the air flowing in the air passage flows through the first heat exchanger without passing through the second heat exchanger toward the outlet opening or the discharge opening, and (ii) a state in which the air flowing in the air passage flows through the second heat exchanger without passing through the first heat exchanger toward the outlet opening or the discharge opening;
an external heat exchanger that is disposed in a space outside the air conditioning case and is configured to exchange heat between the air outside the vehicle cabin and the heat medium;
a heat medium circuit that connects the first heat exchanger, the second heat exchanger and the external heat exchanger by piping through which the heat medium flows, wherein the heat medium circuit includes a plurality of flow path switching valves, each of which is disposed in the piping and is configured to switch a flow of the heat medium; and
an electronic controller that includes at least one of (i) a circuit and (ii) a processor with a memory storing computer program code executable by the processor, wherein the electronic controller is configured to control operation of the air path switching mechanism and components of the heat medium circuit, which include the plurality of flow path switching valves, wherein:
for each heat exchanger, a heat-releasing function is defined as a function of releasing heat from the heat medium flowing inside the heat exchanger to a substance outside the heat exchanger, and a heat-absorbing function is defined as a function of absorbing heat from the substance outside the heat exchanger into the heat medium flowing inside the heat exchanger;
the electronic controller is configured to execute a maximum cooling mode, in which the electronic controller drives each corresponding one of the components of the heat medium circuit such that one of the first heat exchanger and the second heat exchanger performs the heat-releasing function, another one of the first heat exchanger and the second heat exchanger performs the heat-absorbing function, and the external heat exchanger performs the heat-releasing function, and the electronic controller drives the air path switching mechanism such that the air, which has passed through the one of the first heat exchanger and the second heat exchanger without passing through the another one of the first heat exchanger and the second heat exchanger, is discharged from the discharge opening to outside the vehicle cabin, and the air, which has passed through the another one of the first heat exchanger and the second heat exchanger without passing through the one of the first heat exchanger and the second heat exchanger, is blown from the outlet opening into the vehicle cabin; and
the heat medium circuit is configured such that the first heat exchanger and the second heat exchanger are each switchable between the heat-releasing function and the heat-absorbing function.

15. A heat pump system for a vehicle, the heat pump system comprising:
an air conditioning case that has an air passage which is configured to conduct air drawn from outside a vehicle cabin and air drawn from inside the vehicle cabin;
a first heat exchanger that is disposed in the air passage of the air conditioning case and is configured to exchange heat between the air flowing in the air passage and a heat medium;
a second heat exchanger that is disposed downstream of the first heat exchanger in the air passage of the air conditioning case and is configured to exchange heat between the air flowing in the air passage and the heat medium;
an outlet opening that is disposed downstream of the first heat exchanger and the second heat exchanger in the air conditioning case and is configured to blow the air from the air passage into the vehicle cabin;
a discharge opening that is disposed downstream of the first heat exchanger in the air conditioning case and is configured to discharge the air from the air passage to outside the vehicle cabin;
an air path switching mechanism that is configured to switch, within the air passage, a flow path of the air between (i) a state in which the air flowing in the air passage flows through the first heat exchanger without passing through the second heat exchanger toward the outlet opening or the discharge opening, and (ii) a state in which the air flowing in the air passage flows through the second heat exchanger without passing through the first heat exchanger toward the outlet opening or the discharge opening;
an external heat exchanger that is disposed in a space outside the air conditioning case and is configured to exchange heat between the air outside the vehicle cabin and the heat medium;
a heat medium circuit that connects the first heat exchanger, the second heat exchanger and the external heat exchanger by piping through which the heat medium flows, wherein the heat medium circuit includes a plurality of flow path switching valves, each of which is disposed in the piping and is configured to switch a flow of the heat medium; and
an electronic controller that includes at least one of (i) a circuit and (ii) a processor with a memory storing computer program code executable by the processor, wherein the electronic controller is configured to control operation of the air path switching mechanism and components of the heat medium circuit, which include the plurality of flow path switching valves, wherein:
for each heat exchanger, a heat-releasing function is defined as a function of releasing heat from the heat medium flowing inside the heat exchanger to a substance outside the heat exchanger, and a heat-absorbing function is defined as a function of absorbing heat from the substance outside the heat exchanger into the heat medium flowing inside the heat exchanger;
the electronic controller is configured to execute a maximum cooling mode, in which the electronic controller drives each corresponding one of the components of the heat medium circuit such that one of the first heat exchanger and the second heat exchanger performs the heat-releasing function, another one of the first heat exchanger and the second heat exchanger performs the heat-absorbing function, and the external heat exchanger performs the heat-releasing function, and the electronic controller drives the air path switching mechanism such that the air, which has passed through the one of the first heat exchanger and the second heat exchanger without passing through the another one of the first heat exchanger and the second heat exchanger, is discharged from the discharge opening to outside the vehicle cabin, and the air, which has passed through the another one of the first heat exchanger and the second heat exchanger without passing through the one of the first heat exchanger and the second heat exchanger, is blown from the outlet opening into the vehicle cabin;
the air path switching mechanism is configured to switch, within the air passage, the flow path of the air to a state in which the air flowing in the air passage passes through both the first heat exchanger and the second heat exchanger and flows to the outlet opening or the discharge opening;
the electronic controller is configured to execute a cooling mode in which the electronic controller drives each corresponding one of the components of the heat medium circuit such that a heat-absorbing one of the first heat exchanger and the second heat exchanger performs the heat-absorbing function, a remaining one of the first heat exchanger and the second heat exchanger has a flow of the heat medium therethrough shut off or performs the heat-absorbing function, and the external heat exchanger performs the heat-releasing function, and the electronic controller drives the air path switching mechanism such that the air, which has passed through both the first heat exchanger and the second heat exchanger, is blown from the outlet opening into the vehicle cabin; and
at a time of switching from the maximum cooling mode to the cooling mode, the electronic controller shuts off, in the maximum cooling mode, a flow of the heat medium at a high temperature through the one of the first heat exchanger and the second heat exchanger, which performs the heat-releasing function during the maximum cooling mode, and switches the flow being shut off to a flow of the heat medium at a low temperature for the cooling mode in the one of the first heat exchanger and the second heat exchanger, and, after a temperature of the one of the first heat exchanger and the second heat exchanger, through which the flow of the heat medium at the high temperature has been shut off, falls below a temperature of the air on an upstream side of the one of the first heat exchanger and the second heat exchanger, through which the flow of the heat medium at the high temperature has been shut off, the electronic controller drives the air path switching mechanism to a state where the air, which has passed through both the first heat exchanger and the second heat exchanger, is directed to the outlet opening.

16. A heat pump system for a vehicle, the heat pump system comprising:
an air conditioning case that has an air passage which is configured to conduct air drawn from outside a vehicle cabin and air drawn from inside the vehicle cabin;
a first heat exchanger that is disposed in the air passage of the air conditioning case and is configured to exchange heat between the air flowing in the air passage and a heat medium;
a second heat exchanger that is disposed downstream of the first heat exchanger in the air passage of the air conditioning case and is configured to exchange heat between the air flowing in the air passage and the heat medium;
an outlet opening that is disposed downstream of the first heat exchanger and the second heat exchanger in the air conditioning case and is configured to blow the air from the air passage into the vehicle cabin;
a discharge opening that is disposed downstream of the first heat exchanger in the air conditioning case and is configured to discharge the air from the air passage to outside the vehicle cabin;
an air path switching mechanism that is configured to switch, within the air passage, a flow path of the air between (i) a state in which the air flowing in the air passage flows through the first heat exchanger without passing through the second heat exchanger toward the outlet opening or the discharge opening, and (ii) a state in which the air flowing in the air passage flows through the second heat exchanger without passing through the first heat exchanger toward the outlet opening or the discharge opening;
an external heat exchanger that is disposed in a space outside the air conditioning case and is configured to exchange heat between the air outside the vehicle cabin and the heat medium;
a heat medium circuit that connects the first heat exchanger, the second heat exchanger and the external heat exchanger by piping through which the heat medium flows, wherein the heat medium circuit includes a plurality of flow path switching valves, each of which is disposed in the piping and is configured to switch a flow of the heat medium; and
an electronic controller that includes at least one of (i) a circuit and (ii) a processor with a memory storing computer program code executable by the processor, wherein the electronic controller is configured to control operation of the air path switching mechanism and components of the heat medium circuit, which include the plurality of flow path switching valves, wherein:
for each heat exchanger, a heat-releasing function is defined as a function of releasing heat from the heat medium flowing inside the heat exchanger to a substance outside the heat exchanger, and a heat-absorbing function is defined as a function of absorbing heat from the substance outside the heat exchanger into the heat medium flowing inside the heat exchanger;
the electronic controller is configured to execute a maximum cooling mode, in which the electronic controller drives each corresponding one of the components of the heat medium circuit such that one of the first heat exchanger and the second heat exchanger performs the heat-releasing function, another one of the first heat exchanger and the second heat exchanger performs the heat-absorbing function, and the external heat exchanger performs the heat-releasing function, and the electronic controller drives the air path switching mechanism such that the air, which has passed through the one of the first heat exchanger and the second heat exchanger without passing through the another one of the first heat exchanger and the second heat exchanger, is discharged from the discharge opening to outside the vehicle cabin, and the air, which has passed through the another one of the first heat exchanger and the second heat exchanger without passing through the one of the first heat exchanger and the second heat exchanger, is blown from the outlet opening into the vehicle cabin;
the heat medium circuit includes:
a refrigeration cycle that is configured to circulate a refrigerant as a first heat medium; and
a coolant circuit that is configured to circulate a coolant as a second heat medium;
the refrigeration cycle includes:
a compressor that is configured to compress and discharge the refrigerant;
a condenser that is configured to heat the coolant flowing through the coolant circuit and condense the refrigerant by heat exchange between the coolant and the refrigerant;
an expansion valve that is configured to depressurize and expand the refrigerant condensed in the condenser; and
an evaporator that is configured to cool the coolant flowing through the coolant circuit and evaporate the refrigerant by heat exchange between the refrigerant and the coolant flowing through the coolant circuit, wherein the compressor, the condenser, the expansion valve and the evaporator are connected by refrigerant piping which is configured to conduct the refrigerant; and
each of the first heat exchanger, the second heat exchanger and the external heat exchanger is a heat exchanger disposed in the coolant circuit.
